(19) United States
(12) Patent Application Publication
(10) Pub. No.: US 2016/0203671 A1
(43) Pub. Date: Jul. 14, 2016

(54) GAMING DEVICE WITH SUPPLEMENTARY-SYMBOL FEATURE

(71) Applicant: Pridefield Limited, Douglas (IM)

(72) Inventors: Richard VERMAAK, Durban (ZA); Rory Angus HARPUR, Durban (ZA)

(21) Appl. No.: 14/987,658

(22) Filed: Jan. 4, 2016

(30) Foreign Application Priority Data
Jan. 8, 2015 (GB) 1500248.8

(51) Int. Cl. G07F 17/32; G07F 17/34; G06Q 50/34

(52) U.S. Cl. CPC G07F 17/3213; G06Q 50/34; G07F 17/34

(57) ABSTRACT

In one aspect, a method includes: selecting a first symbol-set from a global symbol-group, wherein the first symbol-set includes at least two symbols; displaying on the display the selected first symbol-set; making a determination that a second symbol-set, satisfies a trigger condition; after making the determination, (i) selecting a first supplementary-symbol from a first supplementary symbol-group different from the global symbol-group and (ii) selecting a second supplementary-symbol from a second supplementary symbol-group different from the global symbol-group; displaying on the display the selected first supplementary-symbol; displaying on the display the selected second supplementary-symbol; determining a first amount based on the selected first symbol-set; determining a second amount based on the selected first supplementary-symbol and the selected second supplementary-symbol; determining a payout amount based on a function of the determined first amount and the determined second amount; and displaying the determined payout amount.

### PRIORITY

This application claims priority under 35 U.S.C. §119 to United Kingdom Patent Application No. 1500248.8 filed Jan. 8, 2015, which is hereby incorporated by reference in its entirety.

### TECHNICAL FIELD

This disclosure relates to devices for playing games such as wager games.

### BACKGROUND

Wager games come in a variety of forms, including for example a mechanical slot machine. A mechanical slot machine may include one or more reels, each of which includes multiple symbols distributed around the circumference of the reel. When a player places a wager (e.g., by placing a coin in the machine), the player is allowed to spin the reels. Each reel then comes to a stop, typically with either one of the symbols, or a space in between symbols, in alignment with a pay line. A predetermined winning symbol or a predetermined combination of winning symbols that are aligned with the pay line may result in the player winning the game and receiving a payout. In one example, the machine may include three reels, and the pay line may be a horizontal line disposed across a center of each of the three reels.

In another example of a wager game, a mechanical slot machine may present symbols in a matrix arrangement, with each symbol changing during a spin of the game. For example, the machine may have five columns and three rows of symbols, for a total of fifteen symbols. Such machines often have multiple pay lines, each being defined by a collection of positions within the matrix. For example, the machine may have three pay lines, each corresponding to a respective row of the matrix.

While slot machines were traditionally mechanical, modern slot machines often take the form of a device that includes a graphical user interface (GUI), and that may emulate a mechanical slot machine. The GUI may include a display that displays an image of one or more reels or a matrix as described above, together with animation effects to simulate a spin of the game. A computer software select one or more symbols in response to a spin, and may display the result on the display.

A modern slot machine may also be played over a computer network, such as by a player using a client device that is connected to a server device over the computer network. In this instance, the server device may perform the spins program, which may reside in the device, may randomly of the game and may send data representing the resulting symbols to the client device for display.

Modern slot machines may include various features. For example, a modern slot machine may have a win-multiplier feature, which multiplies a payout of the wager game under certain conditions

### SUMMARY

Viewed from one aspect, the disclosure provides a device including: a display configured to display symbols; a processor; and a computer-readable medium having stored thereon program instructions, that when executed by the processor, cause the device to perform a set of acts including selecting a first symbol-set from a global symbol-group, wherein the first symbol-set includes at least two symbols; displaying on the display the selected first symbol-set; making a determination that a second symbol-set, which is a proper sub-set of the selected first symbol-set, satisfies a trigger condition; after making the determination, (i) selecting a first supplementary-symbol from a first supplementary symbol-group different from the global symbol-group and (ii) selecting a second supplementary-symbol from a second supplementary symbol-group different from the global symbol-group; displaying on the display the selected first supplementary-symbol; displaying on the display the selected second supplementary-symbol; determining a first amount based, at least in part, on the selected first symbol-set; determining a second amount based, at least in part, on the selected first supplementary-symbol and the selected second supplementary-symbol; determining a payout amount based on a function of the determined first amount and the determined second amount; and displaying on the display the determined payout amount.

In some embodiments, the first supplementary symbol-group and the second supplementary symbol-group are different groups. In other embodiments, the first supplementary symbol-group and the second supplementary symbol-group are the same group.

In some embodiments, the first supplementary symbol-group includes ten symbols, each of which depicts a respective numerical digit from 0 to 9.

In some embodiments, the set of acts further includes generating a random number, and the act of selecting the first supplementary-symbol from the first supplementary symbol-group includes, based on the generated random-number, selecting the first supplementary-symbol from the first supplementary symbol-group.

In some embodiments, the act of displaying on the display the selected first supplementary-symbol includes displaying on the display an animated first spin of a first virtual-reel having disposed thereon, each symbol of the first supplementary symbol-group, with the first spin stopping to display the selected first supplementary-symbol.

In some embodiments, the act of displaying on the display the selected second supplementary-symbol includes displaying on the display an animated second spin of a second virtual-reel having disposed thereon, each symbol of the second supplementary symbol-group, with the second spin stopping to display the selected second supplementary-symbol.

In some embodiments, the selected first supplementary-symbol corresponds to a first arrangement-position and the selected second supplementary-symbol corresponds to a second arrangement-position.

In some embodiments, the act of displaying on the display the selected first supplementary-symbol includes displaying on the display the selected first supplementary-symbol arranged according to the first arrangement-position.

In some embodiments, the act of displaying on the display the selected second supplementary-symbol includes displaying on the display the selected second supplementary-symbol arranged according to the second arrangement-position.

In some embodiments where the selected first supplementary-symbol corresponds to a first arrangement-position and the selected second supplementary-symbol corresponds to a second arrangement-position, the set of acts further includes receiving, via a user interface, data representing a wager, and the act of determining the first amount based, at least in part, on the selected first symbol-set includes determining the first amount based, at least in part, on the selected first symbol-set and the represented wager.

In some embodiments where the selected first supplementary-symbol corresponds to a first arrangement-position and the selected second supplementary-symbol corresponds to a second arrangement-position, the act of determining the second amount based, at least in part, on the selected first supplementary-symbol and the selected second supplementary-symbol includes determining the second amount based, at least in part on the selected first supplementary-symbol, the selected second supplementary-symbol, the first arrangement position, and the second arrangement position.

In some embodiments, the act of determining the payout amount based on a function of the determined first amount and the determined second amount includes determining the payout amount by multiplying the determined first amount by the determined second amount. In other embodiments, the act of determining the payout amount based on a function of the determined first amount and the determined second amount includes determining the payout amount by adding the determined first amount to the determined second amount.

In some embodiments, the set of acts further includes: after making the determination, selecting a third supplementary-symbol from a third supplementary symbol-group different from the global symbol-group; and displaying on the display the selected third supplementary-symbol. Further, the act of determining the second amount based, at least in part, on the selected first supplementary-symbol and the selected second supplementary-symbol includes determining the second amount based, at least in part, on the selected first supplementary-symbol, the selected second supplementary-symbol, and the selected third supplementary-symbol.

Viewed from a second aspect, the disclosure provides a method including: selecting, by a device, a first symbol-set from a global symbol-group, wherein the first symbol-set includes at least two symbols; displaying, by a display of the device, the selected first symbol-set; making a determination, by the device, that a second symbol-set, which is a proper sub-set of the selected first symbol-set, satisfies a trigger condition; after making the determination, (i) selecting, by the device, a first supplementary-symbol from a first supplementary symbol-group different from the global symbol-group and (ii) selecting, by the device, a second supplementary-symbol from a second supplementary symbol-group different from the global symbol-group; displaying, by the display, the selected first supplementary-symbol; displaying, by the display, the selected second supplementary-symbol; determining, by the device, a first amount based, at least in part, on the selected first symbol-set; determining, by the device, a second amount based, at least in part, on the selected first supplementary-symbol and the selected second supplementary-symbol; determining, by the device, a payout amount based on a function of the determined first amount and the determined second amount; and displaying, by the display, the determined payout amount.

Viewed from a third aspect, the disclosure provides a server device including a processor and a computer-readable medium storing program instructions, that when executed by the processor, cause the server device to perform a set of acts including: selecting a first symbol-set from a global symbol-group, wherein the first symbol-set includes at least two symbols; transmitting, to a client device having a display, data representing the selected first symbol-set for display of the selected first symbol-set on the display; making a determination that a second symbol-set, which is a proper sub-set of the selected first symbol-set, satisfies a trigger condition; after making the determination, (i) selecting a first supplementary-symbol from a first supplementary symbol-group different from the global symbol-group and (ii) selecting a second supplementary-symbol from a second supplementary symbol-group different from the global symbol-group; transmitting, to the client device, data the selected first supplementary-symbol for display of the selected first supplementary-symbol set on the display; transmitting, to the client device, data representing the selected second supplementary-symbol for display of the selected second supplementary-symbol on the display; determining a first amount based, at least in part, on the selected first symbol-set; determining a second amount based, at least in part, on the selected first supplementary-symbol and the selected second supplementary-symbol; determining a payout amount based on a function of the determined first amount and the determined second amount; and transmitting, to the client device, data representing the determined payout amount for display of the determined payout amount on the display.

In some embodiments, the set of acts further includes transmitting, to the client device, data representing the first arrangement-position for display of the selected first supplementary-symbol in the first arrangement-position on the display.

In some embodiments, the set of acts further include transmitting, to the client device, data representing the second arrangement-position for display of the selected second supplementary-symbol in the second arrangement-position on the display.

In some embodiments, the set of acts further includes receiving, from the client device, data representing a wager. Further, the act of determining the first amount based, at least in part, on the selected first symbol-set includes determining the first amount based, at least in part, on the selected first symbol-set and the represented wager.

In some embodiments, the set of acts further includes: after making the determination, selecting a third supplementary-symbol from a third supplementary symbol-group different from the global symbol-group; and transmitting, to the client device, data representing the selected third supplementary-symbol for display of the selected third supplementary-symbol on the display. Further, determining the second amount based, at least in part, on the selected first supplementary-symbol and the selected second supplementary-symbol determining the second amount based, at least in part, on the selected first supplementary-symbol, the selected second supplementary-symbol, and the selected third supplementary-symbol.

Viewed from a fourth aspect, the disclosure provides a method including: selecting, by a server device, a first symbol-set from a global symbol-group, wherein the first symbol-set includes at least two symbols; transmitting, by the server device, to a client device having a display, data representing the selected first symbol-set for display of the selected first symbol-set on the display; making a determination, by the server device, that a second symbol-set, which is a proper sub-set of the selected first symbol-set, satisfies a trigger condition; after making the determination, (i) selecting, by the server device, a first supplementary-symbol from a first supplementary symbol-group different from the global symbol-group and (ii) selecting, by the server device, a second supplementary-symbol from a second supplementary symbol-group different from the global symbol-group; and transmitting, by the server device, to the client device, data representing the selected first supplementary-symbol for display of the selected first supplementary-symbol set on the display; transmitting, by the server device, to the client device, data representing the selected second supplementary-symbol for display of the selected second supplementary-symbol on the display; determining, by the server device, a first amount based, at least in part, on the selected first symbol-set; determining, by the server device, a second amount based, at least in part, on the selected first supplementary-symbol and the selected second supplementary-symbol; determining, by the server device, a payout amount based on a function of the determined first amount and the determined second amount; and transmitting, by the server device, to the client device, data representing the determined payout amount for display of the determined payout amount on the display.

Viewed from a fifth aspect, the disclosure provides a client device including: a display configured to display symbols; a processor; and a computer-readable medium storing program instructions, that when executed by the processor, cause the client device to perform a set of acts including: receiving, from a server device, data representing a first symbol-set selected from a global symbol-group, wherein the first symbol-set includes at least two symbols; displaying on the display the represented first symbol-set; receiving, from the server device, data representing a first supplementary-symbol selected from a first supplementary symbol-group different from the global symbol-group; receiving, from the server device, data representing a second supplementary-symbol selected from a second supplementary symbol-group different from the global symbol-group; displaying on the display the represented first supplementary-symbol; displaying on the display the represented second supplementary-symbol; receiving, from the server device, data representing a payout amount, wherein the payout amount is based on a function of a first amount and a second amount, wherein the first amount is based, at least in part, on the first symbol-set, and wherein the second amount is based, at least in part, on the first supplementary-symbol and the second supplementary-symbol; and displaying on the display the represented payout amount.

In some embodiments, the set of acts further includes: receiving, via a user interface, data representing a wager; and transmitting, to the server device, data representing the wager. Further, the first amount is based, at least in part, on the first symbol-set and the wager.

In some embodiments, the set of acts further includes receiving, from the server device, data representing a third supplementary-symbol selected from a third supplementary symbol-group different from the global symbol-group; and displaying on the display the represented third supplementary-symbol. Further, the second amount is based, at least part, on the first supplementary-symbol, the second supplementary-symbol, and the third supplementary-symbol.

Viewed from a sixth aspect, the disclosure provides a method including: receiving, by a client device, from a server device, data representing a first symbol-set selected from a global symbol-group, wherein the first symbol-set includes at least two symbols; displaying, by a display of the client device, the represented first symbol-set; receiving, by the client device, from the server device, data representing a first supplementary-symbol selected from a first supplementary symbol-group different from the global symbol-group; receiving, by the client device, from the server device, data representing a second supplementary-symbol selected from a second supplementary symbol-group different from the global symbol-group; displaying, on the display, the represented first supplementary-symbol; displaying, on the display, the represented second supplementary-symbol; and receiving, by the client device, from the server device, data representing a payout amount, wherein the payout amount is based on a function of a first amount and a second amount, wherein the first amount is based, at least in part, on the first symbol-set, and wherein the second amount is based, at least in part, on the first supplementary-symbol and the second supplementary-symbol; and displaying, on the display, the represented payout amount.

The features listed above in connection with embodiments of the first aspect of the disclosure, are equally applicable to embodiments of the second, third, fourth, fifth, and sixth aspects of the disclosure. Further, the features listed above in connection with embodiments of the third aspect of the disclosure, are equally applicable to embodiments of the fourth aspect of the disclosure. In addition, the features listed above in connection with the fifth aspect of the disclosure, are equally applicable to embodiments of the sixth aspect of the disclosure. In embodiments in which a computer-readable medium is used, the product may be non-transitory and store program instructions on physical media such as a DVD, or a solid-state drive, or a hard drive. Alternatively, the product may be transitory and in the form of program instructions provided over a connection such as a network connection which is linked to a network such as the Internet.

### BRIEF DESCRIPTION OF THE DRAWINGS

FIG. 1 is a simplified block diagram of an embodiment of a device in accordance with the disclosure;

FIG. 2 is a simplified block diagram of an example server device connected to an example client device over a computer network, in an embodiment of the disclosure;

FIG. 3A is a first part of a flow chart showing acts in accordance with a method in an embodiment of the disclosure;

FIG. 3B is a second part of the flow chart of FIG. 3A;

FIG. 3C is a third part of the flow chart of FIG. 3A;

FIG. 4 includes diagrams of tables used in accordance with devices and methods in embodiments of the disclosure;

FIG. 5 depicts a first state of a display in accordance with devices and methods in embodiments of the disclosure;

FIG. 6 includes diagrams of additional tables used in accordance with devices and methods in embodiments of the disclosure;

FIG. 7 depicts a second state of a display in accordance with devices and methods in embodiments of the disclosure;

FIG. 8 depicts a third state of a display in accordance with devices and methods in embodiments of the disclosure;

FIG. 9A is a first part of a flow chart showing acts in accordance with another method in an embodiment of the disclosure, in connection with an example server device;

FIG. 9B is a second part of the flow chart of FIG. 9A;

FIG. 9C is a third part of the flow chart of FIG. 9A;

FIG. 10A is a first part of a flow chart showing acts in accordance with another method in an embodiment of the disclosure, in connection with an example client device;

FIG. 10B is a second part of the flow chart of FIG. 10A; and

FIG. 10C is a third part of the flow chart of FIG. 10A.

### DETAILED DESCRIPTION

Throughout this disclosure, any reference to “a” or “an” refers to “at least one,” and any reference to “the” refers to “the at least one,” unless otherwise specified, or unless the context clearly dictates otherwise.

Disclosed herein are devices and methods for playing games such as wager games. In one aspect, the devices and methods provide a supplementary-symbol feature that may enhance traditional wager games (e.g., slot machines or other reel-type games) by providing a player with an actual and/or perceived opportunity to increase a payout amount, thereby increasing the player's interest, anticipation, and excitement in connection with the game. This may in turn benefit a casino or another entity that provides a game with this feature. Indeed, wager games are typically configured to have odds that favor the casino (sometimes referred to as the “house”).

Accordingly, based on the law of averages, casinos often maximize their profits simply by getting more players to play more games. Due to the supplementary-symbol feature, players may be drawn in (e.g., from competing casinos that lack games with such a feature) and they may play the game often.

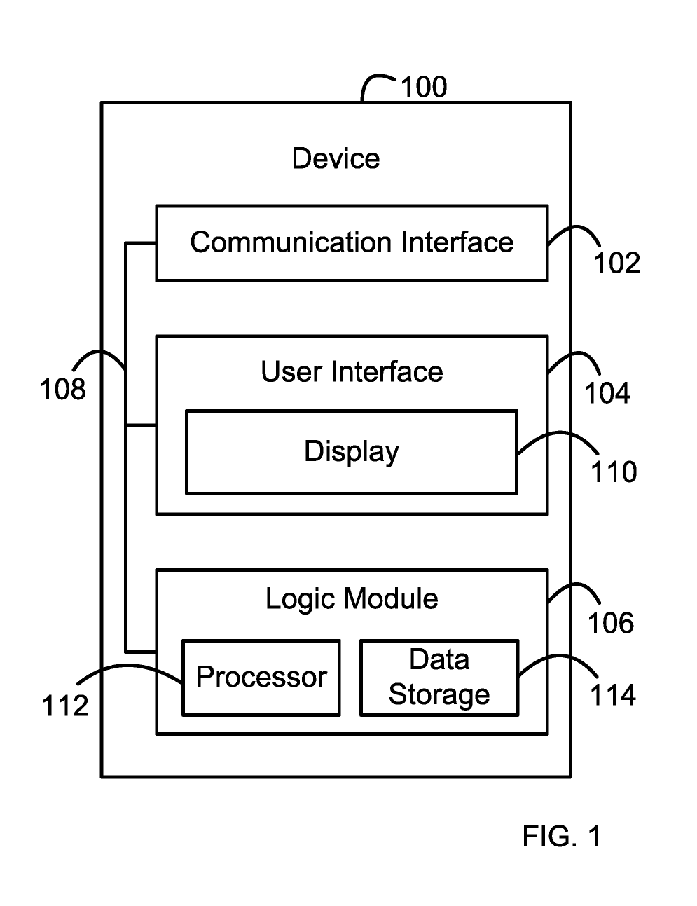

FIG. 1 shows a simplified block diagram of an example device 100 arranged to implement acts or functions in accordance with example methods described herein. The device 100 may take any of a variety of forms, including for example a dedicated gaming device, personal computer, personal digital assistant, mobile phone, smart phone, tablet device, or other computing device.

The device 100 may include a communication interface 102, a user interface 104, and a logic module 106, all of which may be coupled together by a system bus, network, or other connection mechanism 108. The communication interface 102 may include a wired or wireless network communication interface.

The user interface 104 may facilitate interaction with a user (e.g., a player of a game), if applicable. As such, the user interface 104 may take the form of a GUI and may include output components such as a speaker and a display 110, and input components such as a keypad or a touch-sensitive screen. As described in greater detail below, the display 110 may be configured to display, among other things, a symbol in a game.

The logic module 106 may take the form of a processor 112 and a data storage 114. The processor 112 may include a general-purpose processor (e.g., a microprocessor) and/or a special-purpose processor (e.g., a digital signal processor and/or application specific integrated circuit) and may be integrated in whole or in part with the communication interface 102 and/or the user interface 104.

The data storage 114 may include volatile and/or non-volatile storage components and may be integrated in whole or in part with the processor 112. The data storage 114 may take the form of a computer-readable medium and may include software program instructions, that when executed by the processor 114, cause the device 100 to perform one or more of the acts or functions, such as those described herein. Throughout this disclosure, an act or function described as being performed by a device may be performed by one or more component of that device.

The computer-readable medium may be a transitory computer-readable medium or a non-transitory computer-readable medium. The data storage 114 may also include operating system software on which the device 100 may operate.

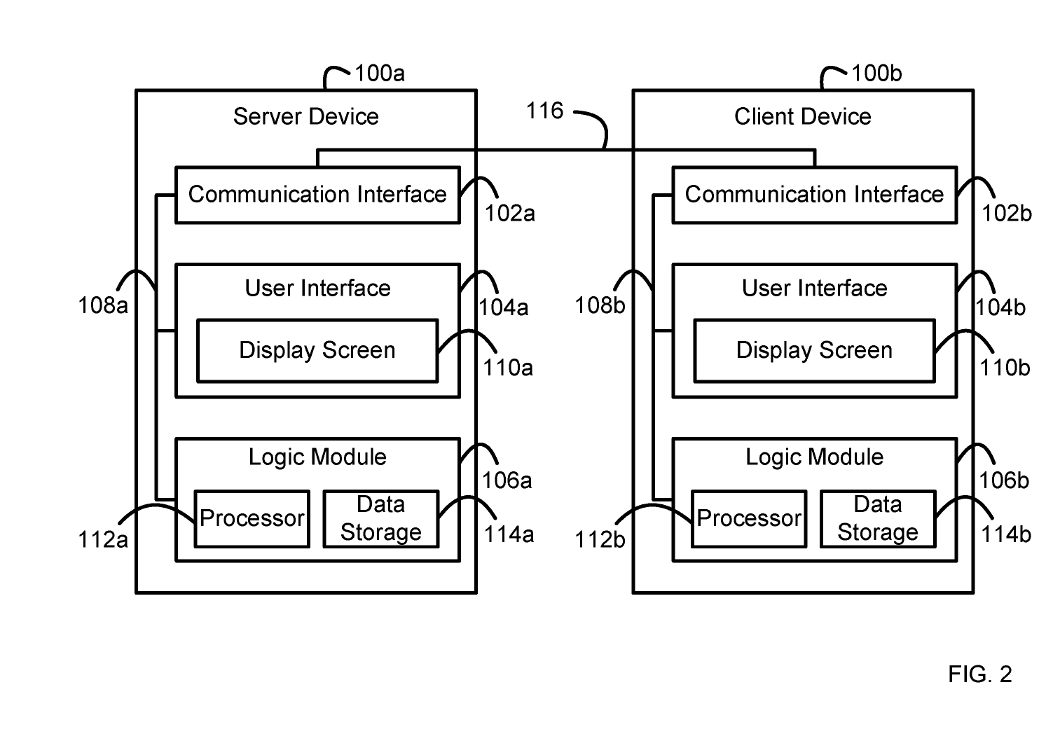

FIG. 2 is a simplified block diagram of an example server device 100a connected to an example client device (sometimes referred to as a workstation) 100b over a computer network 116. The components of the server device 100a and the client device 100b are shown with corresponding “a” and ““b” reference numerals (i.e., based on the device 100). The server device 100a is configured to communicate with the client device 100b over the computer network 116 (via the communication interfaces 102a, 102b). Likewise, the client device 100b is configured to communicate with the server device 100a over the computer network 116. In such server-client based configurations, the server device 100a and/or the client device 100b may perform one or more of the acts or functions, such as those described herein.

The computer network 116 may take a variety of forms. For example, the computer network 116 may be a local area network (LAN) in a casino, such that client devices 100b dispersed throughout the casino may communicate with the server device 100a in the casino. In another example, the computer network 116 may be a wide area network (WAN), such as an Internet network. In such a configuration, the client devices 100b may communicate with the server device 100a via a website portal (for a virtual casino) hosted on the server device 100a.

The computer network 116 may include any of a variety of network topologies and network devices, and may employ traditional network related technologies, including for example the public switched telephone network (PSTN), cable networks, cellular wireless networks, WiFi, and WiMax. Further, the computer network 116 may include one or more databases (e.g., a player credit-account database), to allow for the storing and retrieving of data related to the game.

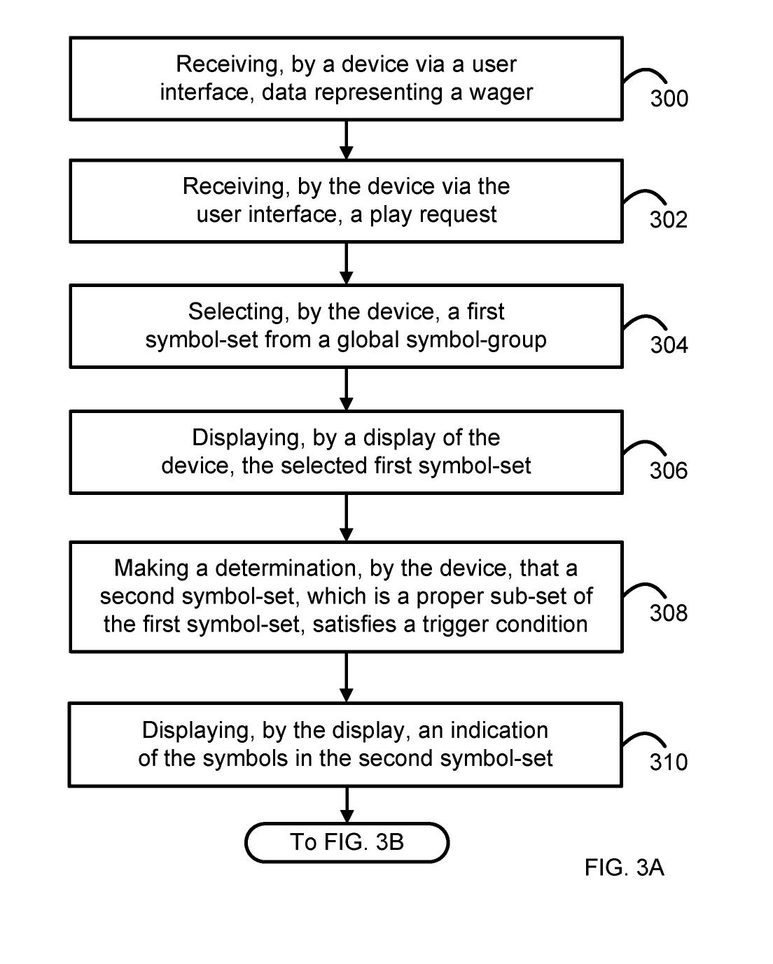

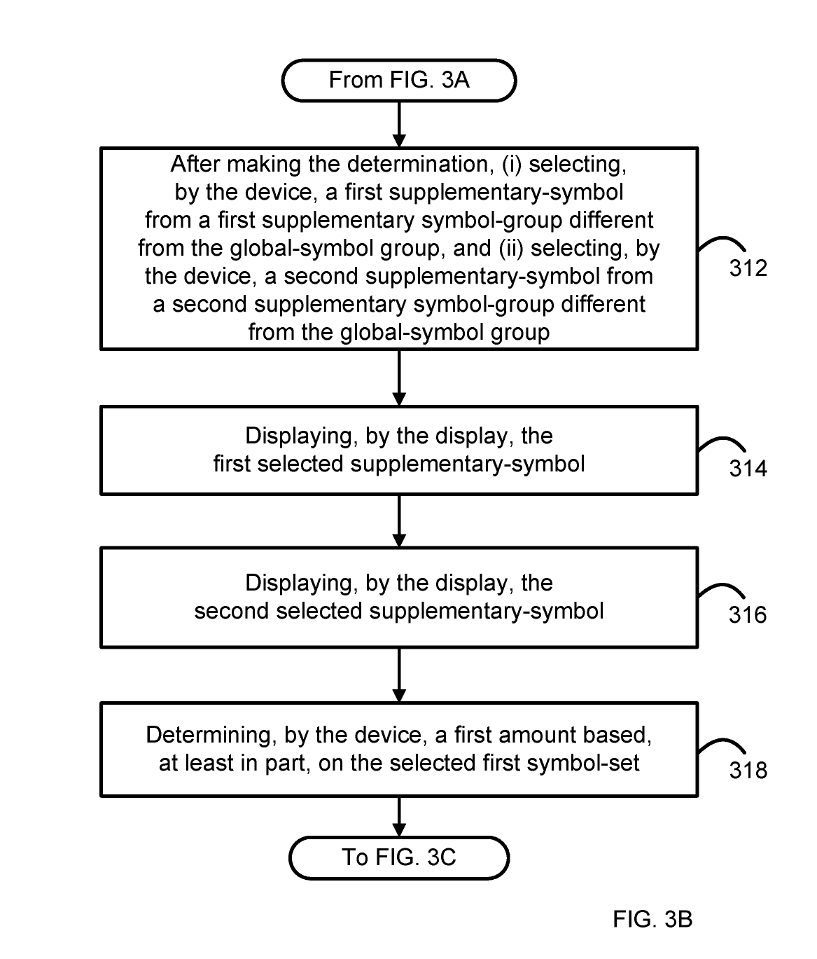

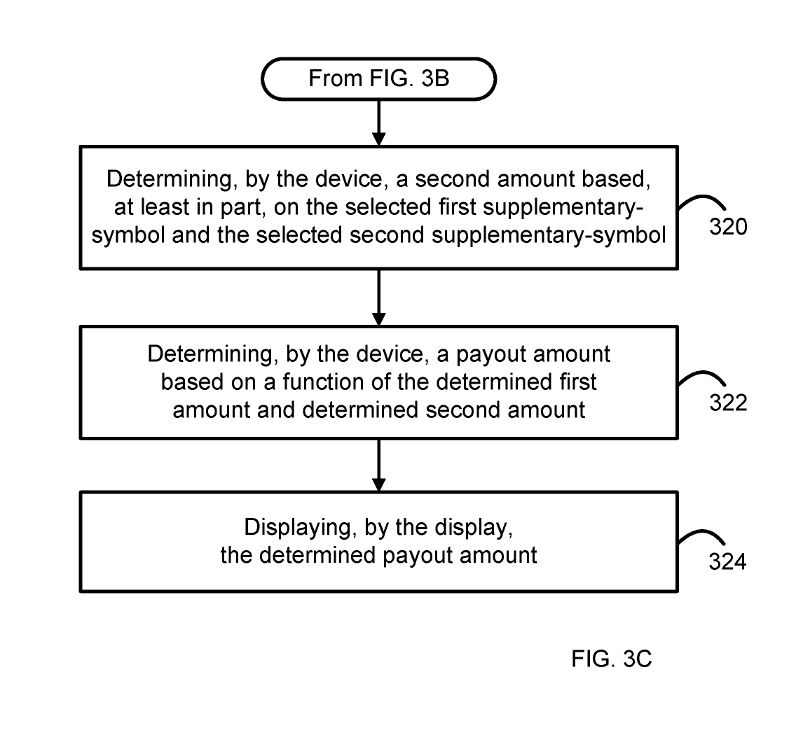

FIGS. 3A-3C show a flow chart showing acts in accordance with an example method in connection with the device 100. The example method relates to a wager game.

At block 300, the method may include receiving, by the device 100 via the user interface 104, data representing a wager. In one example, this may allow a player to enter a wager of the wager game on a keypad of the device 100. In one example, a player may have a corresponding player credit-balance from which the wager may be deducted in response to the device 100 receiving a play request from the player. For example, a player may have a player credit-balance of 100,000, which may be reduced to 99,750 credits upon the player requesting a play of the game with a wager of 250 credits. In one example, the method may further include displaying, by the display 110, the player credit-balance and/or the wager amount.

At block 302, the method may include receiving, by the device, via the user interface 104, a play request (e.g., a “spin” request). In one example, this may allow a player to pull a level or push a button of the device 100 to request a play of the wager game. As noted above, this may result in the player's credit-balance being reduced by the player's wager.

At block 304, the method may include selecting, by the device 100, a first symbol-set from a global symbol-group. In one example, the device 100 selects the first symbol-set from the global symbol-group responsive to the device 100 receiving the play request.

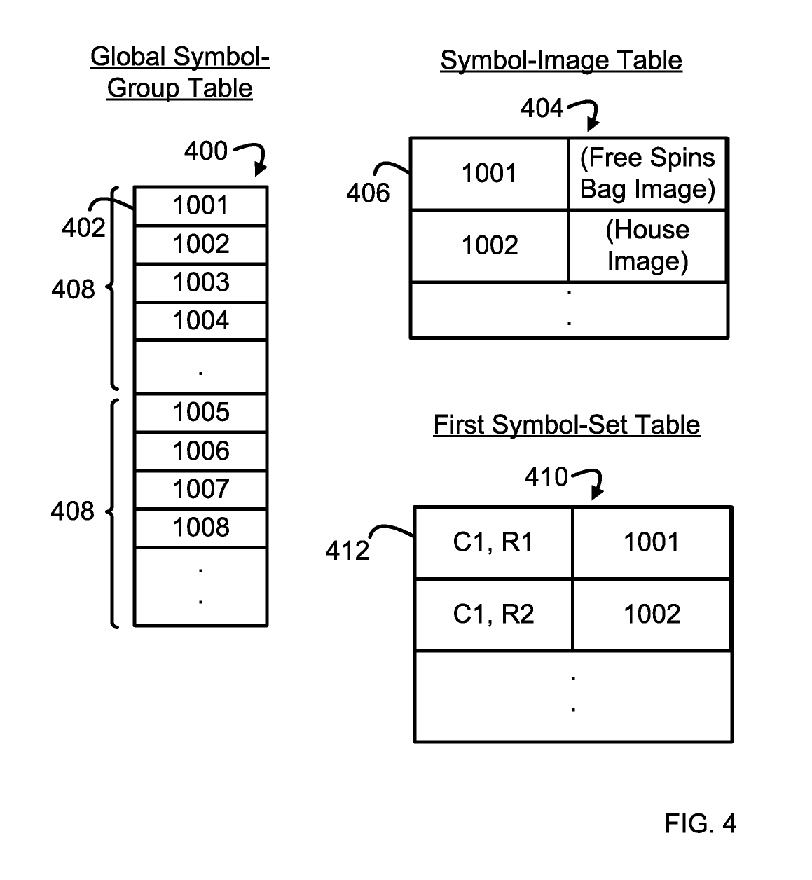

The global symbol-group includes multiple symbols, such as an Orange, an Apple, a Lemon, a Watermelon, a BAR, a White Sheep, a Black Sheep, a House, or a Free-Spins Bag, that may be used in connection with the wager game. The global symbol-group may be customized with particular symbols as desired. In one example, the global symbol-group may be represented as a table (or other data structure) stored in the data storage 114. FIG. 4 shows an example global symbol-group table 400. The global symbol-group table 400 includes multiple records 402, each including an identifier that represents a particular symbol. In one example, the global symbol-group, and therefore the global symbol-group table 400, may be divided into multiple sub-groups 408 as discussed in greater detail below.

The global symbol-group table 400 may be used in connection with a symbol-image table 404, which is shown in FIG. 4. The symbol-image table 404 includes multiple records 406, each including an identifier that represents a particular symbol, and a corresponding displayable image. As such, the symbol-image table 404 may be used to map an identifier in the global symbol-group table 400 to a displayable image.

The selected first symbol-set may be represented by a first symbol-set table 410, which is shown in FIG. 4. The table 410 includes multiple records 412, each including an arrangement position of a symbol, and an identifier that represents the symbol. As such, each symbol in the selected first symbol-set may correspond with a respective arrangement position within an arrangement (e.g., both a column number and row number in a column-and-row arrangement).

In one example, the device 100 may select the first symbol-set by iterating though each arrangement position, and selecting a symbol identifier from among the symbol identifiers in the global symbol-group table 400. In one example, the symbol identifiers are numbers and the device 100 uses a random number generator to select such numbers, and therefore to randomly select symbols. In one example, the selected first symbol-set includes at least two symbols.

In one example, the device 100 may select each of multiple sub-sets in the first symbol-set from a respective sub-group in the global symbol-group. This type of selection may be used when the first symbol-set represents one or more reels in a reel-type wager game. In this instance, each sub-group may include all the symbols of a given reel, and the selected sub-set may include the symbols of the reel that are “in play,” namely those included in the selected first symbol-set.

Returning to FIG. 3A, at block 306, the method may include displaying, by the display 110, the selected first symbol-set. In one example, the device 100 may display the selected first symbol-set on the display 110 by displaying the displayable image associated with each symbol in the selected first symbol-set (e.g., according to the symbol-image table 404).

In one example, the device 100 may display the selected first symbol-set in a column and row arrangement by displaying each symbol in the selected first symbol-set according to its corresponding arrangement position. Further, where the column and row arrangement is used to simulate reels, the device 100 may display each sub-set in a corresponding column of the arrangement, such as by superimposing each sub-set over a virtual reel in the corresponding column.

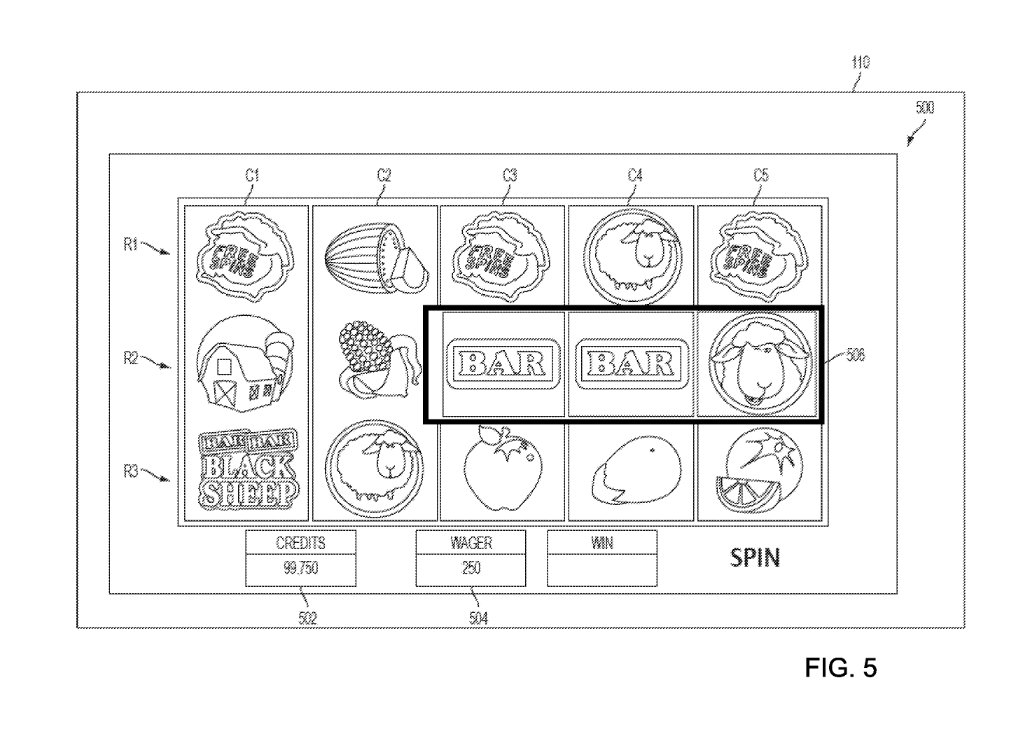

FIG. 5 depicts a first state of the display 110. In particular, FIG. 5 shows an example of a first symbol-set 500 displayed on the display 110. The first symbol-set 500 includes 15 symbols arranged in five columns C1-C5 and three rows R1-R3, with each symbol of the first symbol-set 500 being displayed in a corresponding position of the arrangement. FIG. 5 also shows a player credit-balance 502 of 99,750 credits and a wager amount 504 of 250 credits.

At block 308, the method may include making a determination, by the device 100, that a second symbol-set, which is a proper sub-set of the selected first symbol-set, satisfies a trigger condition. Since the second symbol-set is a proper sub-set of the first symbol-set, the second sub-set consists of at least a portion, but not all of the symbols included in the first symbol-set.

The trigger condition may be one of a variety of different conditions. For example, the trigger condition may be a condition of including a particular combination of symbols. For instance, the second symbol-set may satisfy the trigger condition if it includes three of the same symbol (e.g., three White Sheep symbols or three BAR symbols). As another example, the second symbol set may satisfy the trigger condition if it includes three specific symbols (e.g., two BAR symbols and one Black Sheep). In some examples, the particular combination may be a winning combination as indicated in a payout table.

As another example, the trigger condition may be a particular combination of symbols that correspond with particular arrangement positions. For instance, the second symbol-set may satisfy the trigger condition if it includes specific symbols, namely two BAR symbols and one Black Sheep symbol, across three adjacent arrangement positions on any single row in a column and row arrangement. In one example, the particular combination and particular arrangement positions may be a winning combination as indicated in a payout table. Note that while a few example trigger conditions have been described above, any of a variety of other trigger conditions could be used to suit a desired configuration.

As shown in FIG. 5, the selected first symbol-set 500 satisfies the trigger condition described in the paragraph above since the second symbol-set includes a first BAR symbol positioned at C3, R2, a second BAR symbol positioned at C4, R2, and a Black Sheep symbol positioned at C5, R2. A box 506 around these symbols indicates that the trigger condition has been satisfied.

At block 310, the method may include displaying, by the display 110, an indication of the symbols in the second symbol-set. In one example, the device 100 may display such an indication by highlighting, shading, hatching or adding a border around the symbols, but other indication techniques may also be used.

At block 312, the method may include after making the determination, (i) selecting, by the device 100, a first supplementary-symbol from a first supplementary symbol-group different from the global symbol-group and (ii) selecting, by the device 100, a second supplementary-symbol from a second supplementary symbol-group different from the global symbol-group.

The first supplementary symbol-group includes multiple symbols. The first supplementary symbol-group may be customized with particular symbols as desired. In one example, the first supplementary symbol-group includes ten symbols, each of which depicts a respective numerical digit from 0 to 9.

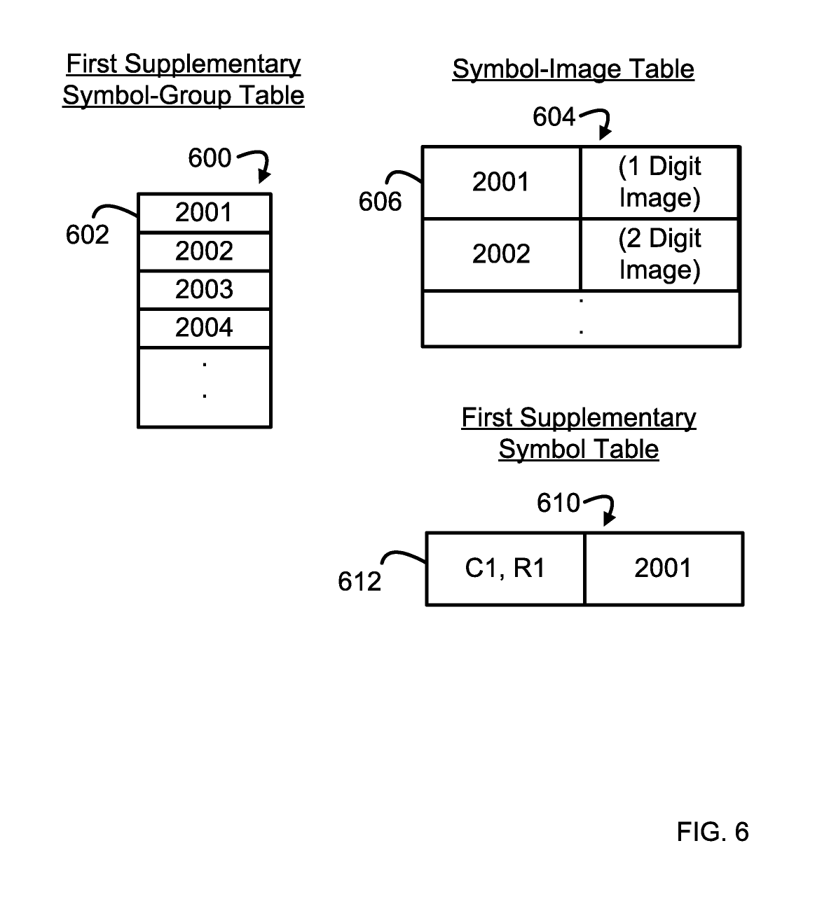

In one example, the first supplementary symbol-group may be represented as a table (or other data structure) stored in the data storage 114. FIG. 6 shows an example first supplementary symbol-group table 600. The first supplementary symbol-group table 600 includes multiple records 602, each including an identifier that represents a particular symbol.

The first supplementary symbol-group table 600 may be used in connection with a symbol-image table 604, which is shown in FIG. 6. The symbol-image table 604 includes multiple records 606, each including an identifier that represents a particular symbol, and a corresponding displayable image. As such, the symbol-image table 604 may be used to map an identifier in the first supplementary symbol-group table 600 to a displayable image.

The selected first supplementary-symbol may correspond with an arrangement position within an arrangement, such as a column and row arrangement. The selected first supplementary-symbol may be represented by a table 610, which is shown in FIG. 6. The table 610 includes a record 612, which includes an arrangement position of the first supplementary-symbol, and an identifier that represents the symbol.

In one example, the device 100 may select the first supplementary-symbol by selecting a symbol identifier from among the symbol identifiers in the first supplementary symbol group-table 600. In one example, the symbol identifiers are numbers and the device 100 uses a random number generator to select a number, and therefore to randomly select a symbol. As such, the method may include responsive to making the determination, generating a random number, and the act of selecting the first supplementary-symbol from the first supplementary symbol-group may include, based on the generated random-number, selecting the first supplementary-symbol from the first supplementary symbol-group.

The device 100 may select the second supplementary-symbol in a similar manner to that in which it selects a first supplementary-symbol. The first supplementary symbol-group and the second supplementary symbol-group may be the same group. Alternatively, the first supplementary symbol-group and the second supplementary symbol-group may be different groups. For instance, in this alternative case, the first supplementary symbol-group may include includes five symbols, each of which depicts a respective numerical digit from 0 to 4, and the second supplementary symbol-group may include includes five symbols, each of which depicts a respective numerical digit from 5 to 9.

After making the determination at block 312, the device 100 may also select additional supplementary-symbols. For instance, after making the determination, the method may include selecting, by the device 100, a third supplementary-symbol from a third supplementary symbol-group different from the global symbol-group.

In some instances, the device may use a generated random number to select multiple (and perhaps ordered) supplementary symbols at once, such as by mapping a generated random number to a first supplementary symbol that represents a numerical digit 1, followed by a second supplementary symbol that represents a numerical digit 2.

At block 314, the method may include displaying, by the display 110, the selected first supplementary-symbol. In one example, the device 100 may display the selected first supplementary-symbol on the display 110 by displaying the displayable image associated with that symbol (e.g. according to the symbol-image table 604).

As indicated above, the selected first supplementary-symbol may correspond to an arrangement-position. In this case, the act of displaying on the display 110 the selected first supplementary-symbol may include displaying on the display 110 the selected first supplementary-symbol arranged according to the arrangement-position.

In one example, the act of displaying on the display 110 the selected first supplementary-symbol may include displaying on the display 110 an animated first spin of a first virtual-reel having disposed thereon, each symbol of the first supplementary symbol-group, with the first spin stopping to display the selected first supplementary-symbol.

At block 316, the method may include displaying, by the display 110, the selected second supplementary-symbol. The device 100 may display the selected second supplementary-symbol in a similar manner to that in which it displays the selected first supplementary-symbol. Accordingly, in one example, the device 100 may display the selected second supplementary-symbol on the display 110 by displaying the displayable image associated with that symbol.

As indicated above, the selected second supplementary-symbol may correspond to an arrangement-position. In this case, the act of displaying on the display 110 the selected first supplementary-symbol may include displaying on the display 110 the selected first supplementary-symbol arranged according to the arrangement-position. In one example, each of multiple arrangement positions may correspond to a respective place column of a number. For example, a first arrangement position may correspond to a tens place column of the number and a second arrangement position may correspond to a ones place column of the number.

In one example, the act of displaying on the display 110 the selected second supplementary-symbol may include displaying on the display 110 an animated second spin of a second virtual-reel having disposed thereon, each symbol of the second supplementary symbol-group, with the second spin stopping to display the selected second supplementary-symbol.

The device 100 may display additional selected supplementary-symbol in a similar manner to that in which it displays the selected first supplementary-symbol. As such, where the device 100 selects a third supplementary-symbol, the method may include the device 100 displaying the selected third supplementary-symbol.

In one example, the selected first supplementary-symbol and the selected second supplementary-symbol (and perhaps additional supplementary symbols, such as the third supplementary symbol), in view of their respective arrangement positions, may collectively represent a number. For example, where the selected first supplementary-symbol is a symbol depicting the numerical digit 1, the selected second supplementary-symbol is a symbol depicting the numerical digit 2, and the selected first supplementary-symbol and the selected second supplementary-symbol are positioned next to each other and in that order across a single row, the selected symbols and corresponding arrangement positions may represent the number twelve.

In another example including three supplementary symbols, where the selected first supplementary-symbol is a symbol depicting the numerical digit 1, the selected second supplementary-symbol is a symbol depicting the numerical digit 2, the selected second supplementary-symbol is a symbol depicting the digit 1, and the selected first supplementary-symbol, the selected second supplementary-symbol, and the selected second supplementary-symbol are positioned next to each other and in that order across a single row, the selected symbols and corresponding arrangement positions may represent the number one-hundred twenty-one.

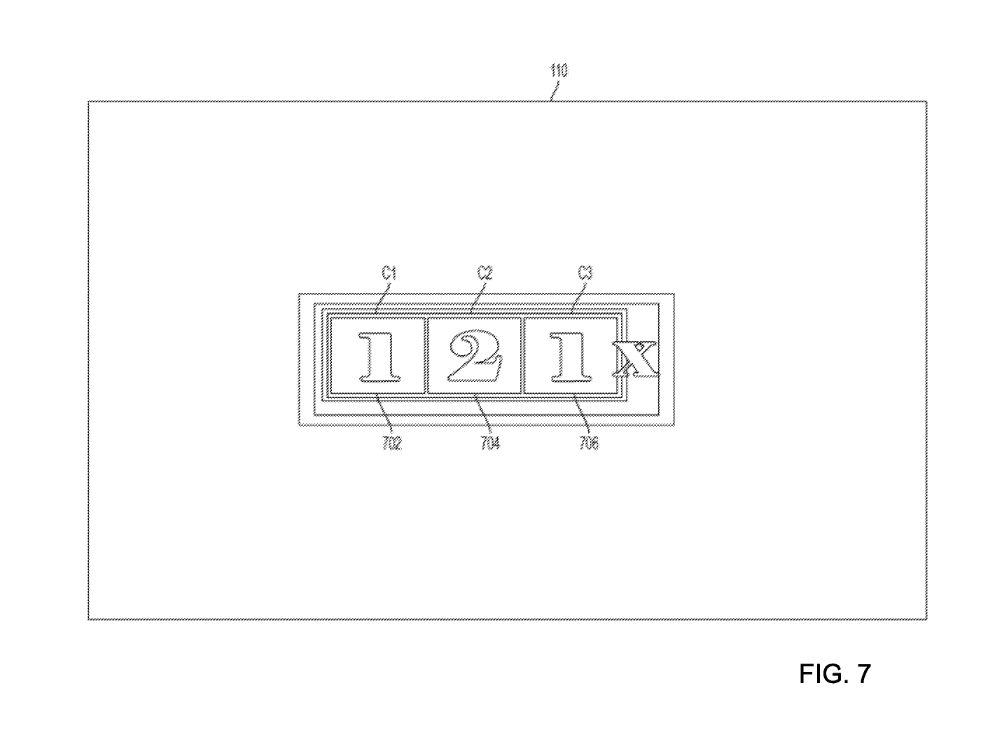

FIG. 7 depicts a second state of the display 110. In particular, FIG. 7 shows an example of a first supplementary-symbol 702, a second supplementary-symbol 704, and a third supplementary-symbol 706 displayed on the display 110. Each of these symbols corresponds with an arrangement position within a three column (C1-C3) and one row (R1) arrangement. In particular, the first supplementary-symbol 702 is arranged in the position C1, R1, the second supplementary-symbol 704 is arranged in the position C2, R1, and the third supplementary-symbol 706 is arranged in the position C3, R1.

As shown in FIG. 7, in one example, the supplementary symbols 702, 704, 706 may be displayed instead of the selected first symbol-set 500 (and related data). However, in another example, the supplementary symbols 702, 704, 706 may be overlayed on the selected first symbol-set 500 (and related data). In another example, the supplementary symbols 702, 704, 706 may be displayed together with (e.g., adjacent to) the selected first symbol-set 500 (and related data).

At block 318, the method may include determining, by the device 100, a first amount based, at least in part, on the selected first symbol-set. In some instances, the act of determining the first amount based, at least in part, on the selected first symbol-set may include determining the first amount based, at least in part, on the selected first symbol-set and the represented wager. In one example, a payout table may map a given symbol set and/or a particular arrangement to a multiplier, and the device 100 may determine the first amount by multiplying the received wager by the multiplier to determine the first payout amount. For instance, where the received wager is 250, and the multiplier is 2 (e.g., based on the row R3 having three fruit-related symbols), the determined first amount may be 500.

At block 320, the method may include determining, by the device 100, a second amount based, at least in part, on the selected first supplementary-symbol and the selected second supplementary-symbol.

In some instances, the act of determining the second amount based, at least in part, on the selected first supplementary-symbol and the selected second supplementary-symbol includes determining the second amount based, at least in part on the selected first supplementary-symbol, the selected second supplementary-symbol, the first arrangement position, and the second arrangement position.

In the case where the device selects a third supplementary-symbol, the act of determining the second amount based, at least in part, on the selected first supplementary-symbol and the selected second supplementary-symbol includes determining the second amount based, at least in part, on the selected first supplementary-symbol, the selected second supplementary-symbol, and the selected third supplementary-symbol.

As discussed above, the selected first supplementary-symbol and the selected second supplementary-symbol (and perhaps additional supplementary symbols, such as the third supplementary symbol), in view of their respective arrangement positions, may collectively represent a number. The act at block 320 may include determining, by the device 100, this number. As such, based on the selected first supplementary-symbol 702, the selected second supplementary-symbol 704, and the selected third supplementary-symbol 706, the device 100 may determine the number 121.

At block 322, the method may include determining, by the device 100, a payout amount based on a function of the determined first amount and the determined second amount.

In one example, the act of determining a payout amount based on a function of the determined first amount and the determined second amount may include determining the payout amount by multiplying the determined first amount by the determined second amount. In another one example, the act of determining a payout amount based on a function of the determined first amount and the determined second amount may include determining the payout amount by adding the determined first amount by the determined second amount. Other functions may be applied as well.

Continuing with the example above, the device 100 may determine a payout amount of 60,500 by multiplying the determined first amount of 500 by the determined second amount of 121.

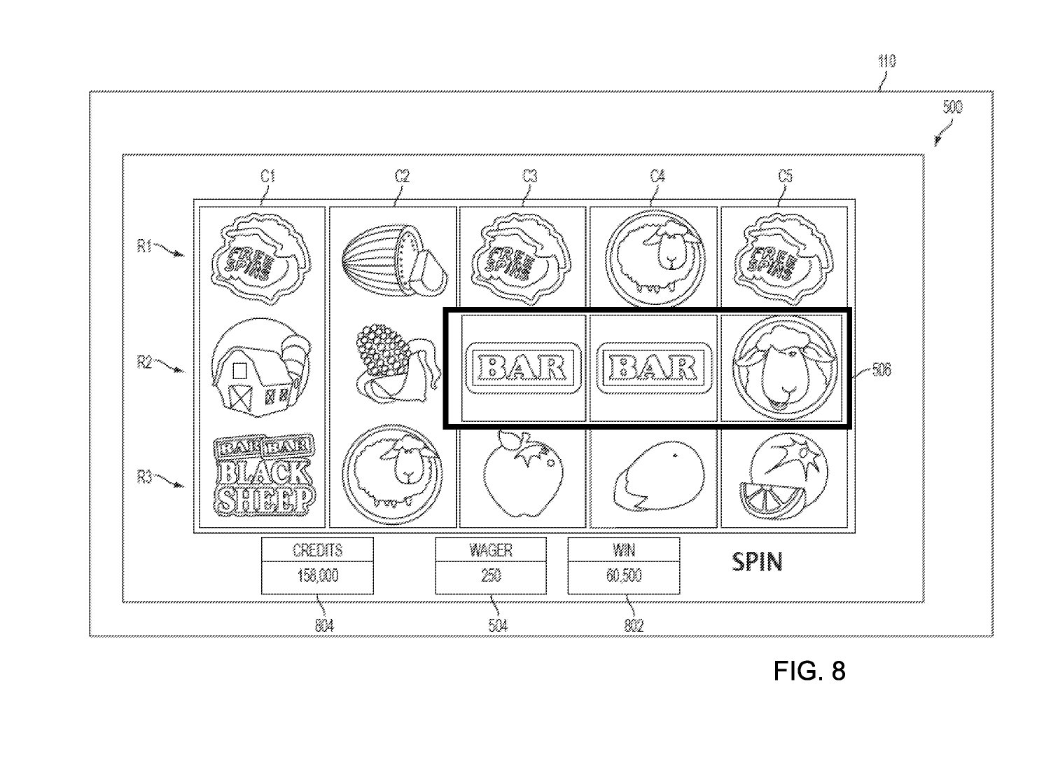

At block 324, the method may include displaying, by the display 110, the determined payout amount. This is shown in FIG. 8, which depicts a third state of the display 110. The third state of the display 110 is the same as the second state of the display 110 as described above, except that the third state of the display 110 shows the determined payout amount 802 of 60,500, and an updated credit balance 804 of 158,000, which reflects the previous credit balance of 97,500 plus the determined payout amount of 60,500.

As shown in FIG. 8, in one example, the selected first symbol-set 500 (and related data) may be displayed instead of the supplementary symbols 702, 704, 706. However, in another example, the selected first symbol-set 500 (and related data) may be overlayed on the supplementary symbols 702, 704, 706. In another example, the selected first symbol-set 500 (and related data) may be displayed together with (e.g., adjacent to) the supplementary symbols 702, 704, 706.

In some instances, the device 100 may physically dispense a corresponding payout (e.g., the determined payout amount) or otherwise facilitate the payout to the player. The device 100 may also perform other actions to award the player. For instance, the device 100 may display an indication of a tangible prize. Other types of awards may be used as well.

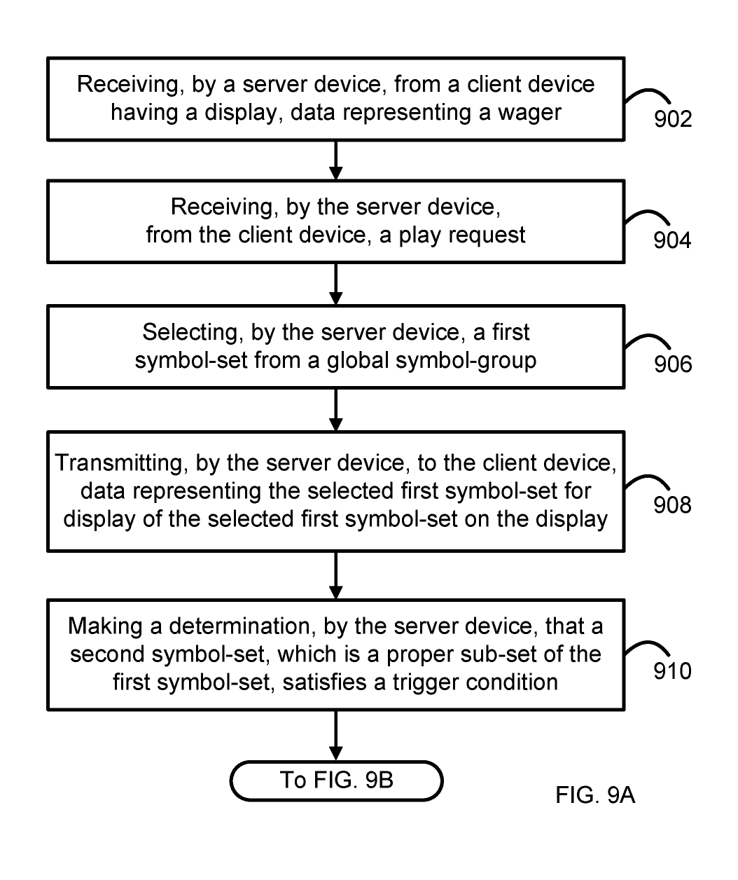

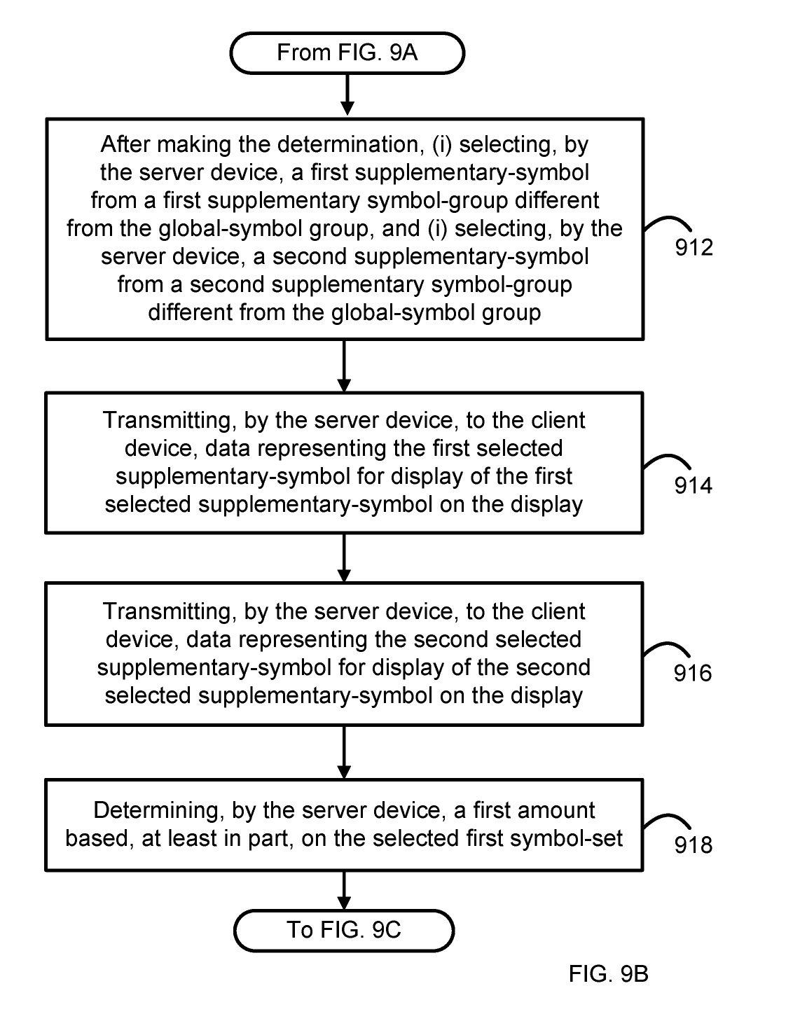

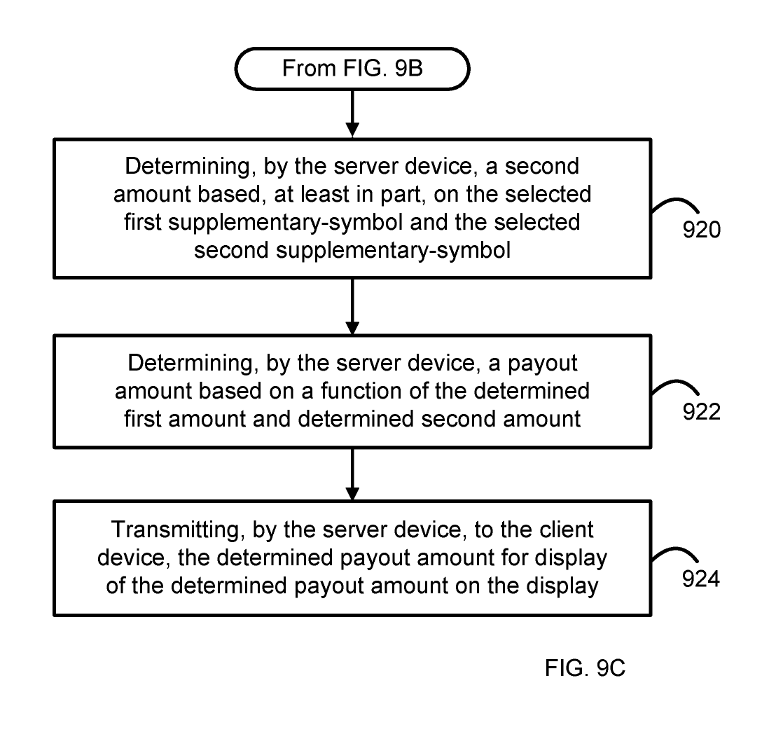

FIGS. 9A-9C show a flow chart showing acts in accordance with an example method in connection with the server device 100a. The example method relates to a wager game. Note that several of the acts described in connection with FIGS. 9A-9C parallel acts described in connection with FIGS. 3A-3C. As such, variations of the acts described in connection with FIGS. 3A-3C are likewise applicable to the acts described in connection with FIGS. 9A-9C. However, for the sake of brevity, these variations are not repeated.

At block 902, the method may include receiving, by the server device 100a, from the client device 100b, data representing a wager.

At block 904, the method may include receiving, by the server device 100a, from the client device 100b, a play request.

At block 906, the method may include selecting, by the server device 100a, a first symbol-set from a global symbol-group.

At block 908, the method may include transmitting, by the server device 100a, to the client device 100b, data representing the selected first symbol-set for display of the selected first symbol-set on the display 110b.

In one example, this may include the server device 100a transmitting a displayable image associated with each symbol in the selected first symbol-set to the client device 100b. In another example, this may include the server device 100a transmitting an identifier associated with each symbol in the selected first symbol-set to the client device 100b. The server device 100a may also send the corresponding arrangement position of each symbol in the selected first symbol-set to the client device 100b. In another example, such arrangement positions may be implied by the order in which the identifiers are sent.

At block 910, the method may include making a determination, by the server device 100a, that a second symbol-set, which is a proper sub-set of the first symbol-set, satisfies a trigger condition.

At block 912, the method may include after making the determination, (i) selecting, by the server device 100a, a first supplementary-symbol from a first supplementary symbol-group different from the global symbol-group and (ii) selecting, by the server device 100a, a second supplementary-symbol from a second supplementary symbol-group different from the global symbol-group.

At block 914, the method may include transmitting, by the server device 100a, to the client device 100b, data representing the first selected supplementary-symbol for display of the first selected supplementary-symbol on the display 110b

At block 916, the method may include transmitting, by the server device 100a, to the client device 100b, data representing the second selected supplementary-symbol for display of the second selected supplementary-symbol on the display 110b.

The sever device 100a may transmit the first selected supplementary-symbol and/or the second selected supplementary-symbol in any of the ways described above in connection with block 908.

At block 918, the method may include determining, by the server device 100a, a first amount based, at least in part, on the selected first symbol-set.

At block 920, the method may include determining, by the server device 100a, a second amount based, at least in part, on the selected first supplementary-symbol and the selected second supplementary-symbol.

At block 922, the method may include determining, by the server device 100a, a payout amount based on a function of the determined first amount and determined second amount.

At block 924, the method may include transmitting, by the server device 100a, to the client device 110b, the determined payout amount for display of the determined payout amount on the display 110b.

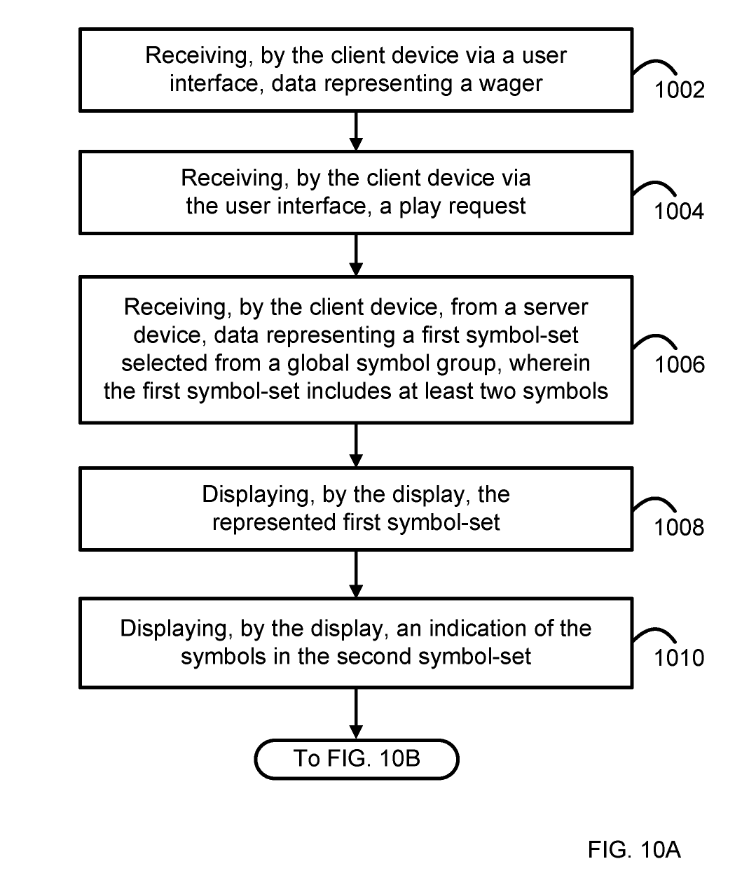

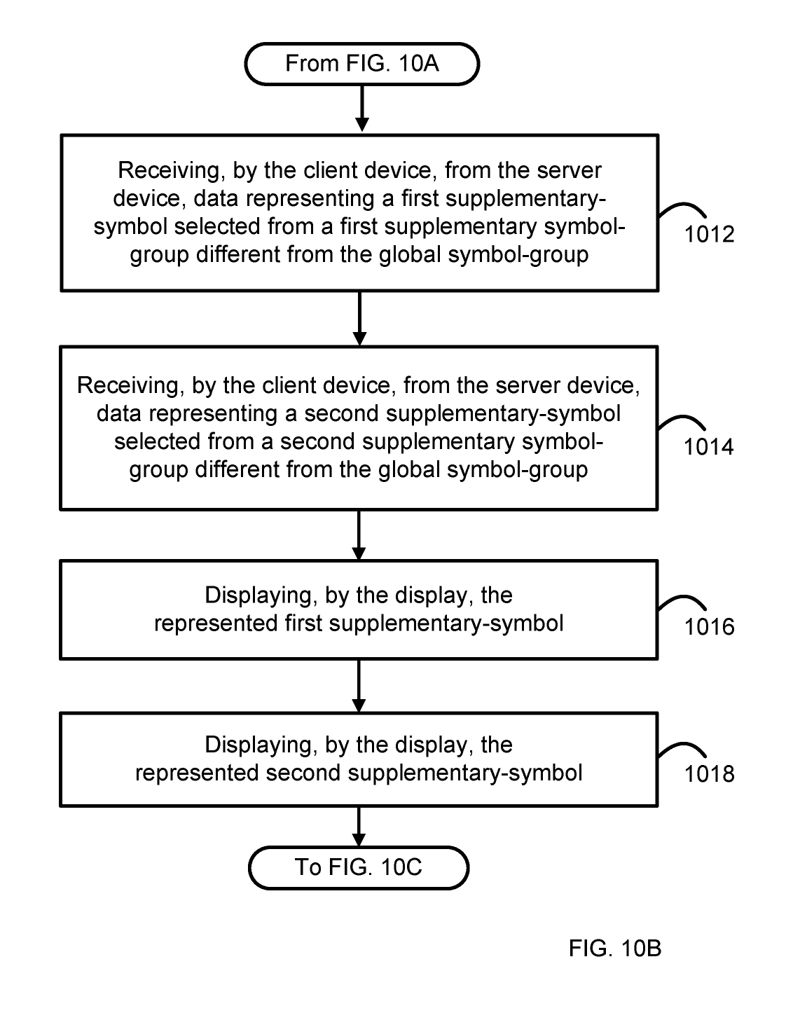

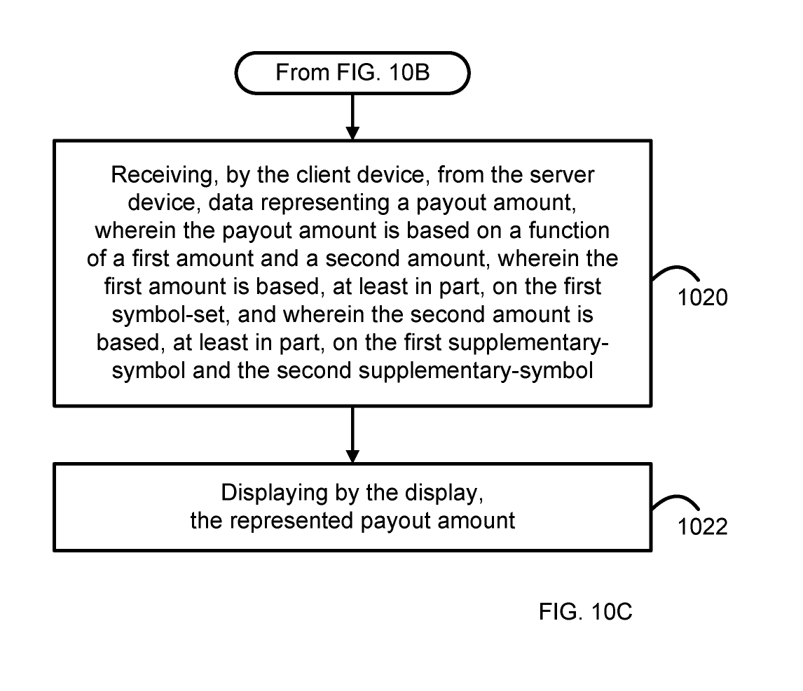

FIGS. 10A-10C show a flow chart showing acts in accordance with an example method in connection with the client device 100b. The example method relates to a wager game. Note that several of the acts described in connection with FIGS. 10A-10C parallel acts described in connection with FIGS. 3A-3C and 9A-9C. As such, variations of the acts described in connection with FIGS. 3A-3C and 9A-9C are likewise applicable to the acts described in connection with FIGS. 10A-10C. However, for the sake of brevity, these variations are not repeated.

At block 1002, the method may include receiving, by the client device 100b via the user interface 104b, data representing a wager.

At block 1004, the method may include receiving, by the client device 100b via the user interface 104b, a play request. (MBHB Docket No. 14-2061-GB)

At block 1006, the method may include receiving, by the client device 100b, from a server device 100a, data representing a first symbol-set selected from a global symbol-group, wherein the first symbol-set includes at least two symbols.

At block 1008, the method may include displaying, by the display 110b, the represented first symbol-set.

At block 1010, the method may include displaying, by the display 110b, an indication of the symbols in the second symbol-set.

At block 1012, the method may include receiving, by the client device 100b, from the server device 100a, data representing a first supplementary-symbol selected from a first supplementary symbol-group different from the global symbol-group.

At block 1014, the method may include receiving, by the client device 100b, from the server device 100a, data representing a second supplementary-symbol selected from a second supplementary symbol-group different from the global symbol-group.

At block 1016, the method may include displaying, by the display 110b, the represented first supplementary-symbol.

At block 1018, the method may include displaying, by the display 110b, the represented second supplementary-symbol.

At block 1020, the method may include receiving, by the client device 100b, from the server device 100a, data representing a payout amount, wherein the payout amount is based on a function of a first amount and a second amount, wherein the first amount is based, at least in part, on the first symbol-set, and wherein the second amount is based, at least in part, on the first supplementary-symbol and the second supplementary-symbol.

At block 1022, the method may include displaying, by the display 110b, the represented payout amount.

The following examples set out further or alternative aspects of the disclosure. The references to items in Figures or to Figures are for ease of reference only and are not limiting on the scope of the disclosures in accordance with these various aspects.

### Example 1

A device 100 comprising: a display 110 configured to display symbols; a processor 112; and a computer-readable medium having stored thereon program instructions, that when executed by the processor 112, cause the device 100 to perform a set of acts comprising:

selecting a first symbol-set from a global symbol-group, wherein the first symbol-set includes at least two symbols;

displaying on the display 110 the selected first symbol-set;

making a determination that a second symbol-set, which is a proper sub-set of the selected first symbol-set, satisfies a trigger condition;

after making the determination, (i) selecting a first supplementary-symbol from a first supplementary symbol-group different from the global symbol-group and (ii) selecting a second supplementary-symbol from a second supplementary symbol-group different from the global symbol-group;

displaying on the display 110 the selected first supplementary-symbol;

displaying on the display 110 the selected second supplementary-symbol;

determining a first amount based, at least in part, on the selected first symbol-set;

determining a second amount based, at least in part, on the selected first supplementary-symbol and the selected second supplementary-symbol;

determining a payout amount based on a function of the determined first amount and the determined second amount; and

displaying on the display 110 the determined payout amount.

### Example 2

The device 100 of example 1, wherein the first supplementary symbol-group and the second supplementary symbol-group are different groups.

### Example 3

The device 100 of example 1, wherein the first supplementary symbol-group and the second supplementary symbol-group are the same group.

### Example 4

The device 100 of one of examples 1-3, wherein the first supplementary symbol-group comprises ten symbols, each of which depicts a respective numerical digit from 0 to 9.

### Example 5

The device 100 of one of examples 1-4, the set of acts further comprising:

responsive to making the determination, generating a random number, wherein selecting the first supplementary-symbol from the first supplementary symbol-group comprises, based on the generated random-number, selecting the first supplementary-symbol from the first supplementary symbol-group.

### Example 6

The device 100 of one of examples 1-5, wherein displaying on the display 110 the selected first supplementary-symbol comprises displaying on the display 110 an animated first spin of a first virtual-reel having disposed thereon, each symbol of the first supplementary symbol-group, with the first spin stopping to display the selected first supplementary-symbol, and

wherein displaying on the display 110 the selected second supplementary-symbol comprises displaying on the display 110 an animated second spin of a second virtual-reel having disposed thereon, each symbol of the second supplementary symbol-group, with the second spin stopping to display the selected second supplementary-symbol.

### Example 7

The device 100 of one of examples 1-6, wherein the selected first supplementary-symbol corresponds to a first arrangement-position and the selected second supplementary-symbol corresponds to a second arrangement-position.

### Example 8

The device 100 of example 7, wherein displaying on the display 110 the selected first supplementary-symbol comprises displaying on the display 110 the selected first supplementary-symbol arranged according to the first arrangement-position, and wherein displaying on the display 110 the selected second supplementary-symbol comprises displaying on the display 110 the selected second supplementary-symbol arranged according to the second arrangement-position.

### Example 9

The device 100 of one of examples 1-8, the set of acts further comprising:

receiving, via a user interface, data representing a wager, wherein determining the first amount based, at least in part, on the selected first symbol-set comprises determining the first amount based, at least in part, on the selected first symbol-set and the represented wager.

### Example 10

The device 100 of example 7 or 8, wherein determining the second amount based, at least in part, on the selected first supplementary-symbol and the selected second supplementary-symbol comprises determining the second amount based, at least in part on the selected first supplementary-symbol, the selected second supplementary-symbol, the first arrangement position, and the second arrangement position.

### Example 11

The device 100 of one of examples 1-10, wherein determining the payout amount based on a function of the determined first amount and the determined second amount comprises determining the payout amount by multiplying the determined first amount by the determined second amount.

### Example 12

The device 100 of one of examples 1-10, wherein determining the payout amount based on a function of the determined first amount and the determined second amount comprises determining the payout amount by adding the determined first amount to the determined second amount.

### Example 13

The device 100 of one of examples 1-12, the set of acts further comprising:

after making the determination, selecting a third supplementary-symbol from a third supplementary symbol-group different from the global symbol-group; and

displaying on the display 110 the selected third supplementary-symbol,

wherein determining the second amount based, at least in part, on the selected first supplementary-symbol and the selected second supplementary-symbol comprises determining the second amount based, at least in part, on the selected first supplementary-symbol, the selected second supplementary-symbol, and the selected third supplementary-symbol.

### Example 14

A method comprising:

selecting, by a device 100, a first symbol-set from a global symbol-group, wherein the first symbol-set includes at least two symbols;

displaying, by a display 110 of the device 100, the selected first symbol-set;

making a determination, by the device 100, that a second symbol-set, which is a proper sub-set of the selected first symbol-set, satisfies a trigger condition;

after making the determination, (i) selecting, by the device 100, a first supplementary-symbol from a first supplementary symbol-group different from the global symbol-group and (ii) selecting, by the device 100, a second supplementary-symbol from a second supplementary symbol-group different from the global symbol-group;

displaying, by the display 110, the selected first supplementary-symbol;

displaying, by the display 110, the selected second supplementary-symbol;

determining, by the device 100, a first amount based, at least in part, on the selected first symbol-set;

determining, by the device 100, a second amount based, at least in part, on the selected first supplementary-symbol and the selected second supplementary-symbol;

determining, by the device 100, a payout amount based on a function of the determined first amount and the determined second amount; and

displaying, by the display 110, the determined payout amount.

### Example 15

The method of example 14, wherein the first supplementary symbol-group and the second supplementary symbol-group are different groups.

### Example 16

The method of example 14, wherein the first supplementary symbol-group and the second supplementary symbol-group are the same group.

### Example 17

The method of one of examples 14-16, wherein the first supplementary symbol-group comprises ten symbols, each of which depicts a respective numerical digit from 0 to 9.

### Example 18

The method of one of examples 14-17, the set of acts further comprising:

responsive to making the determination, generating, by the device 100, a random number,

wherein selecting, by the device 100, the first supplementary-symbol from the first supplementary symbol-group comprises, based on the generated random-number, selecting, by the device 100, the first supplementary-symbol from the first supplementary symbol-group.

### Example 19

The method of one of examples 14-18, wherein displaying, by the display 110, the selected first supplementary-symbol comprises displaying, by the display 110, an animated first spin of a first virtual-reel having disposed thereon, each symbol of the first supplementary symbol-group, with the first spin stopping to display the selected first supplementary-symbol, and

wherein displaying, by the display 110, the selected second supplementary-symbol comprises displaying, by the display 110, an animated second spin of a second virtual-reel having disposed thereon, each symbol of the second supplementary symbol-group, with the second spin stopping to display the selected second supplementary-symbol.

### Example 20

The method of one of examples 14-19, wherein the selected first supplementary-symbol corresponds to a first arrangement-position and the selected second supplementary-symbol corresponds to a second arrangement-position.

### Example 21

The method of example 20, wherein displaying, by the display 110, the selected first supplementary-symbol comprises displaying, by the display 110, the selected first supplementary-symbol arranged according to the first arrangement-position, and wherein displaying, by the display 110, the selected second supplementary-symbol comprises displaying, by the display 110, the selected second supplementary-symbol arranged according to the second arrangement-position.

### Example 22

The method of one of examples 14-21, the set of acts further comprising:

receiving, by the device 100 via a user interface, data representing a wager, wherein determining, by the device 100, the first amount based, at least in part, on the selected first symbol-set comprises determining, by the device 100, the first amount based, at least in part, on the selected first symbol-set and the represented wager.

### Example 23

The method of example 20 or 21, wherein determining, by the device 100, the second amount based, at least in part, on the selected first supplementary-symbol and the selected second supplementary-symbol comprises determining, by the device 100, the second amount based, at least in part on the selected first supplementary-symbol, the selected second supplementary-symbol, the first arrangement position, and the second arrangement position.

### Example 24

The method of one of examples 14-23, wherein determining, by the device 100, the payout amount based on a function of the determined first amount and the determined second amount comprises determining, by the device 100, the payout amount by multiplying the determined first amount by the determined second amount.

### Example 25

The method of one of examples 14-23, wherein determining, by the device 100, the payout amount based on a function of the determined first amount and the determined second amount comprises determining, by the device 100, the payout amount by adding the determined first amount to the determined second amount.

### Example 26

The method of one of examples 14-25, the set of acts further comprising:

after making the determination, selecting, by the device 100, a third supplementary-symbol from a third supplementary symbol-group different from the global symbol-group; and

displaying, by the display 110, the selected third supplementary-symbol,

wherein determining, by the device 100, the second amount based, at least in part, on the selected first supplementary-symbol and the selected second supplementary-symbol comprises determining, by the device 100, the second amount based, at least in part, on the selected first supplementary-symbol, the selected second supplementary-symbol, and the selected third supplementary-symbol.

### Example 27

A server device 100a comprising: a processor 112a and a computer-readable medium storing program instructions, that when executed by the processor 112a, cause the server device 100a to perform a set of acts comprising:

selecting a first symbol-set from a global symbol-group, wherein the first symbol-set includes at least two symbols;

transmitting, to a client device 100b having a display 110b, data representing the selected first symbol-set for display of the selected first symbol-set on the display 110b;

making a determination that a second symbol-set, which is a proper sub-set of the selected first symbol-set, satisfies a trigger condition;

after making the determination, (i) selecting a first supplementary-symbol from a first supplementary symbol-group different from the global symbol-group and (ii) selecting a second supplementary-symbol from a second supplementary symbol-group different from the global symbol-group;

transmitting, to the client device 100b, data representing the selected first supplementary-symbol for display of the selected first supplementary-symbol set on the display 110b;

transmitting, to the client device 100b, data representing the selected second supplementary-symbol for display of the selected second supplementary-symbol on the display 110b;

determining a first amount based, at least in part, on the selected first symbol-set;

determining a second amount based, at least in part, on the selected first supplementary-symbol and the selected second supplementary-symbol;

determining a payout amount based on a function of the determined first amount and the determined second amount; and

transmitting, to the client device 100b, data representing the determined payout amount for display of the determined payout amount on the display 110b.

### Example 28

The server device 100a of example 27, wherein the first supplementary symbol-group and the second supplementary symbol-group are different groups.

### Example 29

The server device 100a of example 27, wherein the first supplementary symbol-group and the second supplementary symbol-group are the same group.

### Example 30

The server device 100a of one of examples 27-29, wherein the first supplementary symbol-group comprises ten symbols, each of which depicts a respective numerical digit from 0 to 9.

### Example 31

The server device 100a of one of examples 27-30, the set of acts further comprising:

responsive to making the determination, generating a random number,

wherein selecting the first supplementary-symbol from the first supplementary symbol-group comprises, based on the generated random-number, selecting the first supplementary-symbol from the first supplementary symbol-group.

### Example 32

The server device 100a of one of examples 27-31, wherein the selected first supplementary-symbol corresponds to a first arrangement-position and the selected second supplementary-symbol corresponds to a second arrangement-position.

### Example 33

The server device 100a of example 32, the set of acts further comprising:

transmitting, to the client device 100b, data representing the first arrangement-position to the client device 100b for display of the selected first supplementary-symbol in the first arrangement-position on the display 110b; and

transmitting, to the client device 100b, data representing the second arrangement-position for display of the selected second supplementary-symbol in the second arrangement-position on the display 110b.

### Example 34

The server device 100a of one of examples 27-33, the set of acts further comprising:

receiving, from the client device 100b, data representing a wager, wherein determining the first amount based, at least in part, on the selected first symbol-set comprises determining the first amount based, at least in part, on the selected first symbol-set and the represented wager.

### Example 35

The server device 100a of example 32 or 33, wherein determining the second amount based, at least in part, on the selected first supplementary-symbol and the selected second supplementary-symbol comprises determining the second amount based, at least in part on the selected first supplementary-symbol, the selected second supplementary-symbol, the first arrangement position, and the second arrangement position.

### Example 36

The server device 100a of one of examples 27-35, wherein determining the payout amount based on a function of the determined first amount and the determined second amount comprises determining the payout amount by multiplying the determined first amount by the determined second amount.

### Example 37

The server device 100a of one of examples 27-35, wherein determining the payout amount based on a function of the determined first amount and the determined second amount comprises determining the payout amount by adding the determined first amount to the determined second amount.

### Example 38

The server device 100a of one of examples 27-37, the set of acts further comprising:

after making the determination, selecting a third supplementary-symbol from a third supplementary symbol-group different from the global symbol-group; and

transmitting, to the client device 100b, data representing the selected third supplementary-symbol for display of the selected third supplementary-symbol on the display 110b,

wherein determining the second amount based, at least in part, on the selected first supplementary-symbol and the selected second supplementary-symbol comprises determining the second amount based, at least in part, on the selected first supplementary-symbol, the selected second supplementary-symbol, and the selected third supplementary-symbol.

### Example 39

A method comprising:

selecting, by a server device 100a, a first symbol-set from a global symbol-group, wherein the first symbol-set includes at least two symbols;

transmitting, by the server device 100a, to a client device 100b having a display 110b, data representing the selected first symbol-set for display of the selected first symbol-set on the display 110b;

making a determination, by the server device 100a, that a second symbol-set, which is a proper sub-set of the selected first symbol-set, satisfies a trigger condition;

after making the determination, (i) selecting, by the server device 100a, a first supplementary-symbol from a first supplementary symbol-group different from the global symbol-group and (ii) selecting, by the server device 100a, a second supplementary-symbol from a second supplementary symbol-group different from the global symbol-group;

transmitting, by the server device 100a, to the client device 100b, data representing the selected first supplementary-symbol for display of the selected first supplementary-symbol set on the display 110b;

transmitting, by the server device 100a, to the client device 100b, data representing the selected second supplementary-symbol for display of the selected second supplementary-symbol on the display 110b;

determining, by the server device 100a, a first amount based, at least in part, on the selected first symbol-set;

determining, by the server device 100a, a second amount based, at least in part, on the selected first supplementary-symbol and the selected second supplementary-symbol;

determining, by the server device 100a, a payout amount based on a function of the determined first amount and the determined second amount; and

transmitting, by the server device 100a, to the client device 100b, data representing the determined payout amount for display of the determined payout amount on the display 110b.

### Example 40

The method of example 39, wherein the first supplementary symbol-group and the second supplementary symbol-group are different groups.

### Example 41

The method of example 39, wherein the first supplementary symbol-group and the second supplementary symbol-group are the same group.

### Example 42

The method of one of examples 39-41, wherein the first supplementary symbol-group comprises ten symbols, each of which depicts a respective numerical digit from 0 to 9.

### Example 43

The method of one of examples 39-42, the set of acts further comprising:

responsive to making the determination, generating, by the server device 100a, a random number,

wherein selecting, by the server device 100a, the first supplementary-symbol from the first supplementary symbol-group comprises, based on the generated random-number, selecting, by the server device 100a, the first supplementary-symbol from the first supplementary symbol-group.

### Example 44

The method of one of examples 39-43, wherein the selected first supplementary-symbol corresponds to a first arrangement-position and the selected second supplementary-symbol corresponds to a second arrangement-position.

### Example 45

The method of example 44, the set of acts further comprising:

transmitting, by the server device 100a, to the client device 100b, data representing the first arrangement-position to the client device 100b for display of the selected first supplementary-symbol in the first arrangement-position on the display 110b; and

transmitting, by the server device 100a, to the client device 100b, data representing the second arrangement-position for display of the selected second supplementary-symbol in the second arrangement-position on the display 110b.

### Example 46

The method of one of examples 39-45, the set of acts further comprising:

receiving, by the server device 100a, from the client device 100b, data representing a wager, wherein determining, by the server device 100a, the first amount based, at least in part, on the selected first symbol-set comprises determining, by the server device 100a, the first amount based, at least in part, on the selected first symbol-set and the represented wager.

### Example 47

The method of example 44 or 46, wherein determining, by the server device 100a, the second amount based, at least in part, on the selected first supplementary-symbol and the selected second supplementary-symbol comprises determining, by the server device 100a, the second amount based, at least in part on the selected first supplementary-symbol, the selected second supplementary-symbol, the first arrangement position, and the second arrangement position.

### Example 48

The method of one of examples 39-47, wherein determining, by the server device 100a, the payout amount based on a function of the determined first amount and the determined second amount comprises determining, by the server device 100a, the payout amount by multiplying the determined first amount by the determined second amount.

### Example 49

The method of one of examples 39-47, wherein determining, by the server device 100a, the payout amount based on a function of the determined first amount and the determined second amount comprises determining, by the server device 100a, the payout amount by adding the determined first amount to the determined second amount.

### Example 50

The method of one of examples 39-49, the set of acts further comprising:

after making the determination, selecting, by the server device 100a, a third supplementary-symbol from a third supplementary symbol-group different from the global symbol-group; and

transmitting, by the server device 100a, to the client device 100b, data representing the selected third supplementary-symbol for display of the selected third supplementary-symbol on the display 110b,

wherein determining, by the server device 100a, the second amount based, at least in part, on the selected first supplementary-symbol and the selected second supplementary-symbol comprises determining, by the server device 100a, the second amount based, at least in part, on the selected first supplementary-symbol, the selected second supplementary-symbol, and the selected third supplementary-symbol.

### Example 51

A client device 100b comprising: a display 110b configured to display symbols; a processor 112b; and a computer-readable medium storing program instructions, that when executed by the processor 112b, cause the client device 100b to perform a set of act comprising:

receiving, from a server device 100a, data representing a first symbol-set selected from a global symbol-group, wherein the first symbol-set includes at least two symbols;

displaying on the display 110b the represented first symbol-set;

receiving, from the server device 100a, data representing a first supplementary-symbol selected from a first supplementary symbol-group different from the global symbol-group;

receiving, from the server device 100a, data representing a second supplementary-symbol selected from a second supplementary symbol-group different from the global symbol-group;

displaying on the display 110b the represented first supplementary-symbol;

displaying on the display 110b the represented second supplementary-symbol;

receiving, from the server device 100a, data representing a payout amount, wherein the payout amount is based on a function of a first amount and a second amount, wherein the first amount is based, at least in part, on the first symbol-set, and wherein the second amount is based, at least in part, on the first supplementary-symbol and the second supplementary-symbol; and

displaying on the display 110b the represented payout amount.

### Example 52

The client device 100b of example 51, wherein the first supplementary symbol-group and the second supplementary symbol-group are different groups.

### Example 53

The client device 100b of example 51, wherein the first supplementary symbol-group and the second supplementary symbol-group are the same group.

### Example 54

The client device 100b of one of examples 51-53, wherein the first supplementary symbol-group comprises ten symbols, each of which depicts a respective numerical digit from 0 to 9.

### Example 55

The client device 100b of one of examples 51-54, wherein displaying on the display 110b the represented first supplementary-symbol comprises displaying on the display 110b an animated first spin of a first virtual-reel having disposed thereon, each symbol of the first supplementary symbol-group, with the first spin stopping to display the represented first supplementary-symbol, and

wherein displaying on the display 110b the selected second supplementary-symbol comprises displaying on the display 110b an animated second spin of a second virtual-reel having disposed thereon, each symbol of the second supplementary symbol-group, with the second spin stopping to display the represented second supplementary-symbol.

### Example 56

The client device 100b of one of examples 51-55, wherein the first supplementary-symbol corresponds to a first arrangement-position and the second supplementary-symbol corresponds to a second arrangement-position.

### Example 57

The client device 100b of example 56, wherein displaying on the display 110b the represented first supplementary-symbol comprises displaying on the display 110b the represented first supplementary-symbol arranged according to the first arrangement-position, and wherein displaying on the display 110b the represented second supplementary-symbol comprises displaying on the display 110b the represented second supplementary-symbol arranged according to the second arrangement-position.

### Example 58

The client device 100b of one of examples 51-57, the set of acts further comprising:

receiving, via a user interface, data representing a wager; and

transmitting, to the server device 100a, data representing the wager, wherein the first amount is based, at least in part, on the first symbol-set and the wager.

### Example 59

The client device 100b of example 56 or 57, wherein the second amount is based, at least in part, on the first supplementary-symbol, the second supplementary-symbol, the first arrangement position, and the second arrangement position.

### Example 60

The client device 100b of one of examples 51-59, wherein the payout amount is the first amount multiplied by the second amount.

### Example 61

The client device 100b of one of examples 51-59, wherein the payout amount is the first amount added to the second amount.

### Example 62

The client device 100b of one of examples 51-61, the set of acts further comprising:

receiving, from the server device 100a, data representing a third supplementary-symbol selected from a third supplementary symbol-group different from the global symbol-group; and

displaying on the display 110b the represented third supplementary-symbol, wherein the second amount is based, at least in part, on the first supplementary-symbol, the second supplementary-symbol, and the third supplementary-symbol.

### Example 63

A method comprising:

receiving, by the client device 100b, from a server device 100a, data representing a first symbol-set selected from a global symbol-group, wherein the first symbol-set includes at least two symbols;

displaying, by a display 110b of the client device 100b, the represented first symbol-set;

receiving, by the client device 100b, from the server device 100a, data representing a first supplementary-symbol selected from a first supplementary symbol-group different from the global symbol-group;

receiving, by the client device 100b, from the server device 100a, data representing a second supplementary-symbol selected from a second supplementary symbol-group different from the global symbol-group;

displaying, by the display 110b, the represented first supplementary-symbol;

displaying, by the display 110b, the represented second supplementary-symbol;

receiving, by the client device 100b, from the server device 100a, data representing a payout amount, wherein the payout amount is based on a function of a first amount and a second amount, wherein the first amount is based, at least in part, on the first symbol-set, and wherein the second amount is based, at least in part, on the first supplementary-symbol and the second supplementary-symbol; and

displaying, by the display 110b, the represented payout amount.

### Example 64

The method of example 63, wherein the first supplementary symbol-group and the second supplementary symbol-group are different groups.

### Example 65

The method of example 63, wherein the first supplementary symbol-group and the second supplementary symbol-group are the same group.

### Example 66

The method of one of examples 63-65, wherein the first supplementary symbol-group comprises ten symbols, each of which depicts a respective numerical digit from 0 to 9.

### Example 67

The method of one of examples 63-66, wherein displaying, by the display 110b, the represented first supplementary-symbol comprises displaying, by the display 110b, an animated first spin of a first virtual-reel having disposed thereon, each symbol of the first supplementary symbol-group, with the first spin stopping to display the represented first supplementary-symbol, and

wherein displaying, by the display 110b, the selected second supplementary-symbol comprises displaying, by the display 110b, an animated second spin of a second virtual-reel having disposed thereon, each symbol of the second supplementary symbol-group, with the second spin stopping to display the represented second supplementary-symbol.

### Example 68

The method of one of examples 63-67, wherein the first supplementary-symbol corresponds to a first arrangement-position and the second supplementary-symbol corresponds to a second arrangement-position.

### Example 69

The method of example 68, wherein displaying, by the display 110b, the represented first supplementary-symbol comprises displaying, by the display 110b, the represented first supplementary-symbol arranged according to the first arrangement-position, and wherein displaying, by the display 110b, the represented second supplementary-symbol comprises displaying, by the display 110b, the represented second supplementary-symbol arranged according to the second arrangement-position.

### Example 70

The method of one of examples 63-69, the set of acts further comprising:

receiving, by the client device 100b via a user interface, data representing a wager; and

transmitting, by the client device 100b, to the server device 100a, data representing the wager, wherein the first amount is based, at least in part, on the first symbol-set and the wager.

### Example 71

The method of example 68 or 69, wherein the second amount is based, at least in part, on the first supplementary-symbol, the second supplementary-symbol, the first arrangement position, and the second arrangement position.

### Example 72

The method of one of examples 63-71, wherein the payout amount is the first amount multiplied by the second amount.

### Example 73

The method of one of examples 63-71, wherein the payout amount is the first amount added to the second amount.

### Example 74

The method of one of examples 63-73, the set of acts further comprising:

receiving, by the client device 100b, from the server device 100a, data representing a third supplementary-symbol selected from a third supplementary symbol-group different from the global symbol-group; and

displaying, by the display 110b, the represented third supplementary-symbol, wherein the second amount is based, at least in part, on the first supplementary-symbol, the second supplementary-symbol, and the third supplementary-symbol.

While one or more acts of the disclosed methods have been described as being performed by the certain entities (e.g., the device 100, the server device 100a, or the client device 100b), one or more of the acts may be performed by any entity, including but not limited to those described herein. As such, while this disclosure includes examples in which the server device 100a performs select acts and transmits data to the client device 100b, such that the client device 100b may receive the data and perform complementing acts, variations to those acts may be performed while adhering to the general server-client dichotomy and the scope of the disclosed devices and methods.

For example, rather than the server device 100a transmitting select data (e.g., data representing a symbol set) to the client device 100b, such that the client device may generate and display appropriate images, the server device 100a may itself generate the images and transmit them to the client device 100b for display. Indeed, it will be appreciated by one of ordinary skill in the art that the “break point” between the server device's acts and the client device's acts may be varied with ease.

Further, the acts described throughout this disclosure need not be performed in the disclosed order, although in some examples, the recited order may be preferred. Also, not all acts need to be performed to achieve the desired advantages of disclosed devices and methods, and therefore not all acts are required.

While examples have been described in terms of select embodiments, alterations and permutations of these embodiments will be apparent to those of ordinary skill in the art. Other changes, substitutions, and alterations are also possible without departing from the disclosed devices and methods in their broader aspects as set forth in the following claims.

1. A device comprising: a display configured to display symbols; a processor; and a computer-readable medium having stored thereon program instructions, that when executed by the processor, cause the device to perform a set of acts comprising:
selecting a first symbol-set from a global symbol-group, wherein the first symbol-set includes at least two symbols;
displaying on the display the selected first symbol-set;
making a determination that a second symbol-set, which is a proper sub-set of the selected first symbol-set, satisfies a trigger condition;
after making the determination, (i) selecting a first supplementary-symbol from a first supplementary symbol-group different from the global symbol-group and (ii) selecting a second supplementary-symbol from a second supplementary symbol-group different from the global symbol-group;
displaying on the display the selected first supplementary-symbol;
displaying on the display the selected second supplementary-symbol;
determining a first amount based, at least in part, on the selected first symbol-set;
determining a second amount based, at least in part, on the selected first supplementary-symbol and the selected second supplementary-symbol;
determining a payout amount based on a function of the determined first amount and the determined second amount; and
displaying on the display the determined payout amount.

2. The device of claim 1, the set of acts further comprising:
responsive to making the determination, generating a random number,
wherein selecting the first supplementary-symbol from the first supplementary symbol-group comprises, based on the generated random-number, selecting the first supplementary-symbol from the first supplementary symbol-group.

3. The device of claim 1, wherein displaying on the display the selected first supplementary-symbol comprises displaying on the display an animated first spin of a first virtual-reel having disposed thereon, each symbol of the first supplementary symbol-group, with the first spin stopping to display the selected first supplementary-symbol, and
wherein displaying on the display the selected second supplementary-symbol comprises displaying on the display an animated second spin of a second virtual-reel having disposed thereon, each symbol of the second supplementary symbol-group, with the second spin stopping to display the selected second supplementary-symbol.

4. The device of claim 1, wherein the selected first supplementary-symbol corresponds to a first arrangement-position and the selected second supplementary-symbol corresponds to a second arrangement-position.

5. The device of claim 4, wherein displaying on the display the selected first supplementary-symbol comprises displaying on the display the selected first supplementary-symbol arranged according to the first arrangement-position, and wherein displaying on the display the selected second supplementary-symbol comprises displaying on the display the selected second supplementary-symbol arranged according to the second arrangement-position.

6. The device of claim 1, the set of acts further comprising:
receiving, via a user interface, data representing a wager, wherein determining the first amount based, at least in part, on the selected first symbol-set comprises determining the first amount based, at least in part, on the selected first symbol-set and the represented wager.

7. The device of claim 4, wherein determining the second amount based, at least in part, on the selected first supplementary-symbol and the selected second supplementary-symbol comprises determining the second amount based, at least in part on the selected first supplementary-symbol, the selected second supplementary-symbol, the first arrangement position, and the second arrangement position.

8. The device of claim 1, wherein determining the payout amount based on a function of the determined first amount and the determined second amount comprises determining the payout amount by multiplying the determined first amount by the determined second amount.

9. The device of claim 1, wherein determining the payout amount based on a function of the determined first amount and the determined second amount comprises determining the payout amount by adding the determined first amount to the determined second amount.

10. The device of claim 1, the set of acts further comprising:
after making the determination, selecting a third supplementary-symbol from a third supplementary symbol-group different from the global symbol-group; and
displaying on the display the selected third supplementary-symbol,
wherein determining the second amount based, at least in part, on the selected first supplementary-symbol and the selected second supplementary-symbol comprises determining the second amount based, at least in part, on the selected first supplementary-symbol, the selected second supplementary-symbol, and the selected third supplementary-symbol.

11. A method comprising:
selecting, by a device, a first symbol-set from a global symbol-group, wherein the first symbol-set includes at least two symbols;
displaying, by a display of the device, the selected first symbol-set;
making a determination, by the device, that a second symbol-set, which is a proper sub-set of the selected first symbol-set, satisfies a trigger condition;
after making the determination, (i) selecting, by the device, a first supplementary-symbol from a first supplementary symbol-group different from the global symbol-group and (ii) selecting, by the device, a second supplementary-symbol from a second supplementary symbol-group different from the global symbol-group;
displaying, by the display, the selected first supplementary-symbol;
displaying, by the display, the selected second supplementary-symbol;
determining, by the device, a first amount based, at least in part, on the selected first symbol-set;
determining, by the device, a second amount based, at least in part, on the selected first supplementary-symbol and the selected second supplementary-symbol;
determining, by the device, a payout amount based on a function of the determined first amount and the determined second amount; and
displaying, by the display, the determined payout amount.

12. The method of claim 11, further comprising:
responsive to making the determination, generating, by the device, a random number,
wherein selecting, by the device, the first supplementary-symbol from the first supplementary symbol-group comprises, based on the generated random-number, selecting, by the device, the first supplementary-symbol from the first supplementary symbol-group.

13. The method of claim 11, wherein displaying, by the display, the selected first supplementary-symbol comprises displaying, by the display, an animated first spin of a first virtual-reel having disposed thereon, each symbol of the first supplementary symbol-group, with the first spin stopping to display the selected first supplementary-symbol, and
wherein displaying, by the display, the selected second supplementary-symbol comprises displaying, by the display, an animated second spin of a second virtual-reel having disposed thereon, each symbol of the second supplementary symbol-group, with the second spin stopping to display the selected second supplementary-symbol.

14. The method of claim 11, wherein the selected first supplementary-symbol corresponds to a first arrangement-position and the selected second supplementary-symbol corresponds to a second arrangement-position.

15. The method of claim 14, wherein displaying, by the display, the selected first supplementary-symbol comprises displaying, by the display, the selected first supplementary-symbol arranged according to the first arrangement-position, and wherein displaying, by the display, the selected second supplementary-symbol comprises displaying on the display the selected second supplementary-symbol arranged according to the second arrangement-position.

16. A server device comprising: a processor and a computer-readable medium storing program instructions, that when executed by the processor, cause the server device to perform a set of acts comprising:
selecting a first symbol-set from a global symbol-group, wherein the first symbol-set includes at least two symbols;
transmitting, to a client device having a display, data representing the selected first symbol-set for display of the selected first symbol-set on the display;
making a determination that a second symbol-set, which is a proper sub-set of the selected first symbol-set, satisfies a trigger condition;
after making the determination, (i) selecting a first supplementary-symbol from a first supplementary symbol-group different from the global symbol-group and (ii) selecting a second supplementary-symbol from a second supplementary symbol-group different from the global symbol-group;
transmitting, to the client device, data representing the selected first supplementary-symbol for display of the selected first supplementary-symbol set on the display;
transmitting, to the client device, data representing the selected second supplementary-symbol for display of the selected second supplementary-symbol on the display;
determining a first amount based, at least in part, on the selected first symbol-set;
determining a second amount based, at least in part, on the selected first supplementary-symbol and the selected second supplementary-symbol;
determining a payout amount based on a function of the determined first amount and the determined second amount; and
transmitting, to the client device, data representing the determined payout amount for display of the determined payout amount on the display.

17. The server device of claim 16, the set of acts further comprising:
responsive to making the determination, generating a random number,
wherein selecting the first supplementary-symbol from the first supplementary symbol-group comprises, based on the generated random-number, selecting the first supplementary-symbol from the first supplementary symbol-group.

18. The server device of claim 16, wherein the selected first supplementary-symbol corresponds to a first arrangement-position and the selected second supplementary-symbol corresponds to a second arrangement-position.

19. The server device of claim 18, the set of acts further comprising:
transmitting, to the client device, data representing the first arrangement-position to the client device for display of the selected first supplementary-symbol in the first arrangement-position on the display; and
transmitting, to the client device, data representing the second arrangement-position for display of the selected second supplementary-symbol in the second arrangement-position on the display.

20. The server device of one of claim 16, the set of acts further comprising:
receiving, from the client device, data representing a wager, wherein determining the first amount based, at least in part, on the selected first symbol-set comprises determining the first amount based, at least in part, on the selected first symbol-set and the represented wager.
